(19) United States
(12) Patent Application Publication
(10) Pub. No.: US 2025/0233949 A1
(43) Pub. Date: Jul. 17, 2025

(54) INFORMATION PROCESSING APPARATUS, METHOD OF CONTROLLING INFORMATION PROCESSING APPARATUS, AND INSPECTION SYSTEM

(71) Applicant: CANON KABUSHIKI KAISHA, Tokyo (JP)

(72) Inventor: SHUN NAKAMURA, Kanagawa (JP)

(21) Appl. No.: 19/018,551

(22) Filed: Jan. 13, 2025

(30) Foreign Application Priority Data
Jan. 16, 2024 (JP) 2024-004590

(51) Int. Cl. H04N 1/00; G06T 7/00

(52) U.S. Cl. CPC H04N 1/00045; G06T 7/001; H04N 1/00074; H04N 1/0009; G06T 2207/10008; G06T 2207/30144

(57) ABSTRACT

An information processing apparatus inspecting a printed sheet includes: a storage unit that stores correct character string data used for data collation inspection in association with a template including contents of inspection setting in a case where a type of the inspection includes the data collation inspection in which whether a specific character string is printed correctly on the printed sheet is determined by collating with the correct character string; at least one memory that stores instructions; and at least one processor that executes the instructions to: perform the inspection setting based on a template selected by a user from the template stored in the storage unit; and control a user interface screen that allows the user to perform the selection, in which the correct character string data associated with the template selected by the user is displayed on the user interface screen while allowing for changing of the data.

### BACKGROUND

### Field of the Disclosure

The present disclosure relates to a technique of image inspection of a printed product.

### Description of the Related Art

There has been proposed an inspection system to inspect an image of a printed product outputted by a printing apparatus. Specifically, image quality of the printed product is inspected based on a result obtained by comparing a scanned image obtained by scanning the printed product and a reference image (a correct image) used for the inspection. The above-described inspection includes design inspection in which a printing defect such as stain and color missing is inspected. Additionally, there also have been inspections called character string inspection in which a character string obtained by reading a character on the printed product and code inspection in which a character string obtained from a code of the printed product. In the character string inspection and the code inspection, data collation with correct data is performed; for this reason, in general, the inspections are collectively called data collation inspection.

Before performing various types of inspections of the printed product, it is necessary to perform various types of inspection setting according to details of the inspections. Specifically, it is setting of an inspection target region, setting of a parameter such as a threshold of the image quality to detect the printing defect, setting of the correct data for the data collation, or the like. As a method of performing those various types of inspection setting easily and simply, Japanese Patent Laid-Open No. 2022-067104 discloses the following technique. It is a technique in which the setting of the inspection target region used frequently in the design inspection is registered in advance as a template, the template registered in advance is used in a case of performing the same design inspection, and thus a load of the inspection setting is reduced.

### SUMMARY

An information processing apparatus according to embodiments of the present disclosure is an information processing apparatus inspecting a printed sheet, including: a storage unit that stores data of a correct character string used for data collation inspection in association with a template including contents of inspection setting in a case where a type of the inspection includes the data collation inspection in which whether a specific character string is printed correctly on the printed sheet is determined by collating with the correct character string; at least one memory that stores instructions; and at least one processor that executes the instructions to: perform the inspection setting based on a template selected by a user from the template stored in the storage unit; and control a user interface screen that allows the user to perform the selection, in which the data of the correct character string associated with the template selected by the user is displayed on the user interface screen while allowing for changing of the data.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration including an inspection apparatus of the present disclosure.

FIG. 2 is a configuration diagram of an image forming apparatus of the present disclosure.

FIG. 3 is a diagram describing a configuration of a printer unit in the image forming apparatus.

FIG. 4A is a diagram describing the inspection apparatus.

FIG. 4B is a diagram describing the inspection apparatus.

FIG. 5A is a block diagram illustrating an internal configuration of an inspection apparatus control unit.

FIG. 5B is a block diagram illustrating the internal configuration of the inspection apparatus control unit.

FIG. 6 is a diagram describing an overall flow of inspection using the inspection apparatus.

FIG. 7 is a diagram illustrating an example of an inspection job management screen of the inspection apparatus.

FIG. 8A is a diagram illustrating an example of an inspection setting screen of the inspection apparatus.

FIG. 8B is a diagram illustrating an example of the inspection setting screen of the inspection apparatus.

FIG. 8C is a diagram illustrating an example of the inspection setting screen of the inspection apparatus.

FIG. 9 is a diagram illustrating an example of an inspection setting list screen of the inspection apparatus.

FIG. 10 is a diagram describing a control flow of inspection setting processing of the inspection apparatus.

FIG. 11A is a diagram illustrating an example of a selection screen of favorite inspection setting of the inspection apparatus.

FIG. 11B is a diagram illustrating an example of the selection screen of the favorite inspection setting of the inspection apparatus.

FIG. 12 is a diagram illustrating an example of a registration screen of the favorite inspection setting of the inspection apparatus.

FIG. 13 is a diagram describing a control flow of the inspection apparatus.

FIG. 14 is a diagram illustrating an example of an inspection result display screen of the inspection apparatus.

FIG. 15 is a diagram describing a control flow of the inspection setting processing of the inspection apparatus.

FIG. 16A is a diagram describing a control flow of the inspection setting processing of the inspection apparatus.

FIG. 16B is a diagram describing a control flow of the inspection setting processing of the inspection apparatus.

FIG. 17A is a diagram illustrating an example of the inspection setting screen of the inspection apparatus.

FIG. 17B is a diagram illustrating an example of the inspection setting screen of the inspection apparatus.

FIG. 17C is a diagram illustrating an example of the inspection setting screen of the inspection apparatus.

FIG. 17D is a diagram illustrating an example of the inspection setting screen of the inspection apparatus.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. In addition, the same components are denoted by the same reference numerals. Further, each process (step) in the flowcharts and the sequence charts is denoted by a reference numeral starting with S.

### First Embodiment

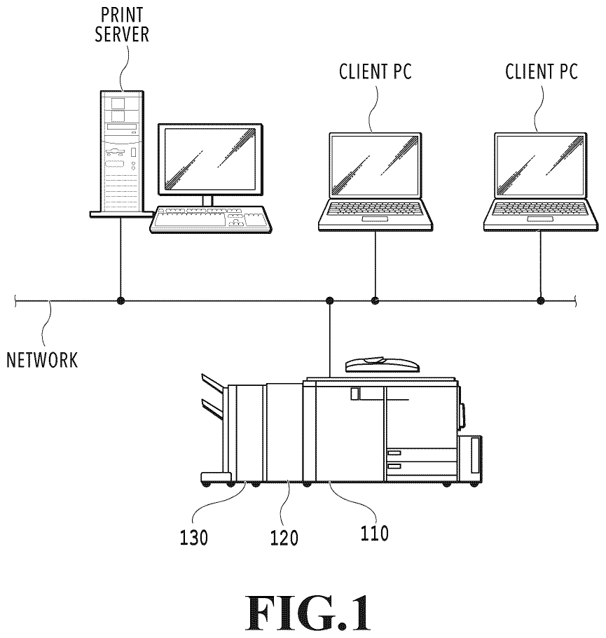

FIG. 1 is a system configuration example including an inspection apparatus according to the present embodiment. An inspection system illustrated in FIG. 1 includes an image forming apparatus (a printing apparatus) 110, an inspection apparatus 120, and a finisher 130. The image forming apparatus 110 processes various input data and prints the processed image data on a sheet (a printing sheet). The inspection apparatus 120 receives a printed product outputted from the image forming apparatus 110 and inspects output contents. Additionally, as for the inspection apparatus 120, it is described in the present embodiment that a control unit that controls inspection setting and the like of the inspection is arranged in the inspection apparatus 120. That is, the information processing apparatus is built in the inspection apparatus 120; however, it is not limited thereto. The inspection apparatus 120 may include the information processing apparatus as a separate body, and the control unit may be included in the information processing apparatus as the separate body. Additionally, the information processing apparatus including the control unit may be arranged outside the inspection apparatus 120. The finisher 130 receives the printed sheet inspected by the inspection apparatus 120.

The image forming apparatus 110 is connected to an external print server or client computer (client PC) via a network. The inspection apparatus 120 is connected one-to-one with the image forming apparatus 110 via a communication cable. Additionally, the finisher 130 is also connected one-to-one with the image forming apparatus 110 via another communication cable. Moreover, the inspection apparatus 120 and the finisher 130 are also connected to each other via a yet another communication cable. In the present embodiment, an in-line inspection apparatus that performs image formation, image inspection, and finishing throughout the processing.

### <Configuration of Image Forming Apparatus>

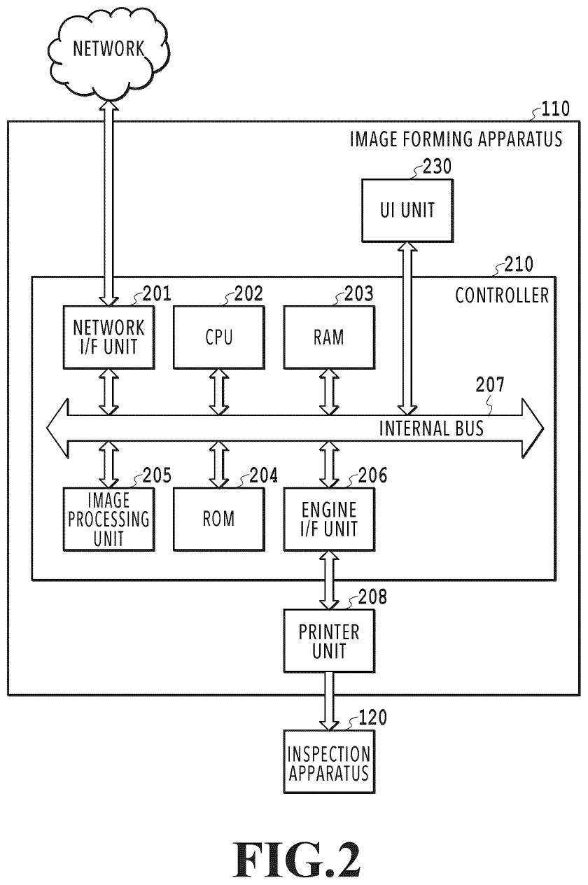

FIG. 2 is a configuration diagram of the image forming apparatus 110 according to the present embodiment. The image forming apparatus 110 of the present embodiment is an example of the image forming apparatus of the present disclosure and includes a controller 210, a printer unit 208, and a UI unit 230. Note that, the UI unit 230 includes various switches, LED displayers, and the like for operation.

An image or a document created by a software application such as a not-illustrated printer driver on the client PC or the print server on the network is transmitted to the image forming apparatus 110 via the network as PDL data. The network is assumed to be, for example, the Internet, a local area network (LAN), and so on. In the image forming apparatus 110, the controller 210 receives the transmitted PDL data. The PDL data received in this process is data as a printing target in the image forming apparatus 110 and is data in which arrangement of a design and data expected as an actual printed product, a page order, imposition information, and the like are defined (prepressed).

The controller 210 is connected to the printer unit 208, receives the PDL data from the client PC or the print server to convert into printing data that can be processed by the printer unit 208, and outputs the printing data to the printer unit 208. The printer unit 208 prints an image based on the printing data outputted from the controller 210. Note that, the printer unit 208 in the description of the present embodiment is an electrophotography type printing engine. However, the printing type is not limited thereto and may be another type such as an ink jet type, a thermal transfer type, and the like. The UI unit 230 is operated by a user and used to select various functions and provide an operation instruction. This UI unit 230 includes a liquid crystal display in which a touch panel is provided on a front surface, a keyboard on which various keys and the like such as a start key, a stop key, and a numeric keypad, and the like.

Next, details of the controller 210 are described. The controller 210 includes a network I/F (interface) unit 201, a CPU 202, a RAM 203, a ROM 204, an image processing unit 205, an engine I/F unit 206, and an internal bus 207. The network I/F unit 201 is an interface that receives the PDL data transmitted from the client PC or the print server.

The CPU 202 controls overall the image forming apparatus 110 by using a program and data stored in the RAM 203 and the ROM 204 and executes the later-described processing performed by the controller 210. The RAM 203 includes a working area used in a case where the CPU 202 executes various types of processing. The ROM 204 stores a program to cause the CPU 202 to execute the later-described various types of processing, data, setting data of the controller 210, and the like.

The image processing unit 205 performs image processing for printing on the PDL data received by the network I/F unit 201 according to the setting from the CPU 202 and generates the printing data that can be processed by the printer unit 208. The image processing unit 205 generates the image data including plural color components for each pixel by rasterizing the received PDL data. The plural color components are independent color components of a color space of RGB (red, green, and blue) or the like. The image data includes a value of 8-bit (256 gradations) for one color component for each pixel. In other words, the image data is multivalued bitmap data including a multivalued pixel. Additionally, in the above-described rasterization, attribute data indicating an attribute of the pixel of the image data for each pixel is also generated in addition to the image data. This attribute data indicates which type of object the pixel belongs to and is, for example, a value indicating a type of the object such as a character, a line, a graphic, an image, and a background. The image processing unit 205 uses the generated image data and attribute data to generate the printing data by performing image processing such as color conversion from an RGB color space into a CMYK (cyan, magenta, yellow, and black) color space and screen processing.

The engine I/F unit 206 is an interface that transmits the printing data generated by the image processing unit 205 to the printer unit 208. The internal bus 207 is a system bus that connects the above-described units 201 to 206 to each other.

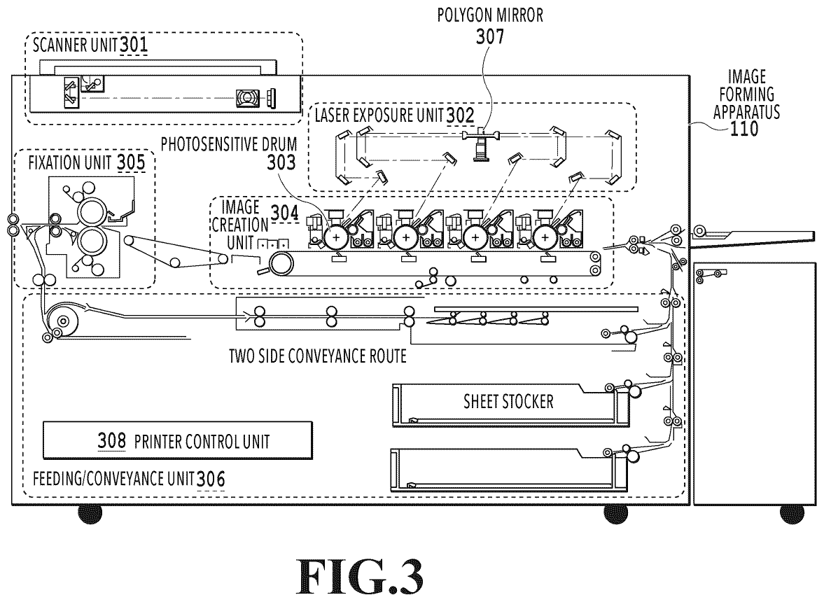

FIG. 3 is a diagram describing a configuration of the printer unit 208 in the above-described image forming apparatus 110. The image forming apparatus 110 includes a scanner unit 301, a laser exposure unit 302, a photosensitive drum 303, an image creation unit 304, a fixation unit 305, a feeding/conveyance unit 306, and a printer control unit 308 that controls the above.

The scanner unit 301 optically reads a document image by irradiating the document put on a platen glass with lighting and creates the image data by converting the image into an electric signal. The laser exposure unit 302 allows a light ray such as laser light modulated according to the above-described image data to enter a rotary polygon mirror (a polygon mirror) 307 rotating at a constant angular speed and irradiates the photosensitive drum 303 with light as reflection scanning light.

The image creation unit 304 rotates and drives the photosensitive drum 303, charges the photosensitive drum 303 with a charger, and develops a latent image formed on the photosensitive drum by the above-described laser exposure unit by using toner. This processing is implemented by four development units (development stations) of a series of electrophotography process in which the toner image is transferred on a sheet and a small amount of toner that is not transferred and remains on the photosensitive drum is collected. The four sequential development units arrayed in the order of cyan (C), magenta (M), yellow (Y), and black (K) execute an image creation operation of magenta, yellow, and black after a predetermined time has passed after the image creation of the cyan station starts.

The fixation unit 305 is formed of a combination of a roller and a belt, includes a heat source such as a halogen heater built therein, and melts and fixes the toner on the sheet on which the toner image is transferred by the above-described image creation unit with heat and pressure. Note that, in a case of printing on a thick sheet, since the sheet is thick and the heat conductivity is low, the speed of passing through the fixation unit 305 needs to be half the normal speed, for example. Because of this, in a case of printing on a thick sheet, a sheet conveyance speed through each unit other than the fixation unit 305 is also at half speed, and thus the printing speed of the image forming apparatus 110 becomes half speed.

The feeding/conveyance unit 306 includes one or more sheet stockers such as a sheet cassette or a paper deck and separates one sheet from the plural sheets stored in the sheet stocker according to an instruction of the above-described printer control unit 308 to convey the sheet to the image creation unit 304 and the fixation unit 305. The sheet is conveyed, and a toner image of each color is transferred by the above-described development station so as to form a full-color toner image on the sheet finally. Additionally, in a case of forming images on two surfaces of the sheet, respectively, the sheet that has passed through the fixation unit 305 is controlled to pass through a conveyance route for the conveyance to the image creation unit 304 again.

The printer control unit 308 communicates with the controller 210 that controls overall the image forming apparatus 110 and executes control according to the instruction therefrom. Additionally, the printer control unit 308 manages a state of each unit of the above-described scanner, laser exposure, image creation, fixation, and feeding/conveyance and provides an instruction to each unit such that overall the image forming apparatus 110 smoothly operates while keeping the consistency thereof.

### <Internal Configuration of Inspection Apparatus>

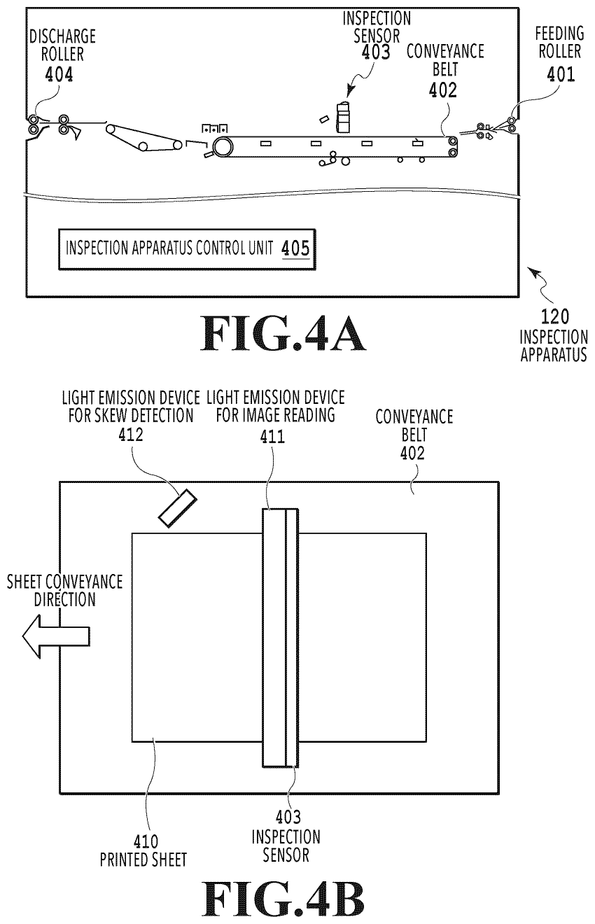

FIG. 4A is a schematic configuration diagram illustrating inside of the inspection apparatus 120. The printed sheet printed and outputted from the image forming apparatus 110 is conveyed to the inspection apparatus 120 by a feeding roller 401. Thereafter, the printed sheet is read by an inspection sensor 403 above a conveyance belt 402 while being conveyed by the conveyance belt 402. The image (the scanned image) read by this inspection sensor 403 is used to perform the inspection processing by an inspection apparatus control unit 405. Additionally, the inspection apparatus control unit 405 also controls overall the inspection apparatus 120. An inspection result is transmitted to the finisher 130. After the inspection is performed, the printed sheet is conveyed from a discharge roller 404 to the finisher 130. The inspection sensor 403 may have a structure of reading also a lower side of the conveyance belt 402 by the inspection sensor so as to be able to treat a two-sided printed product.

FIG. 4B is a top view illustrating a portion including the conveyance belt 402. In this case, the inspection sensor 403 is a line sensor that reads an image of an entire surface of a conveyed printed sheet 410, one line at a time. A light emission device 411 for image reading irradiates the printed sheet with light during the reading by the inspection sensor 403. A light emission device 412 for skew detection reads whether the printed sheet is skew with respect to a sheet paper conveyance direction during the conveyance over the conveyance belt 402. With the irradiation of the conveyed printed sheet with light from an oblique direction, a shadow image of an end portion of the printed sheet is read, and the skew is detected. In the present embodiment, the reading of the shadow image on the printed sheet is performed by the inspection sensor 403. Another reading sensor other than the inspection sensor 403 may be used to detect the skew.

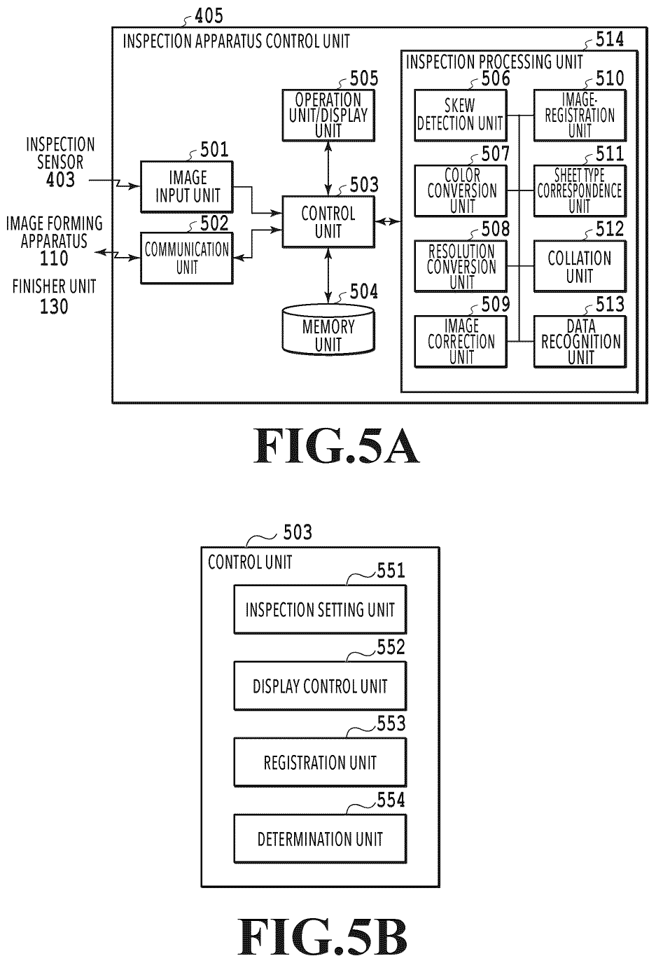

FIG. 5A is a block diagram illustrating an internal configuration of the inspection apparatus control unit 405. The inspection apparatus control unit 405 including a CPU includes a control unit 503, and the inspection apparatus 120 is controlled by this control unit 503. An image input unit 501 receives the scanned image read by the inspection sensor 403. The received scanned image is saved in a memory unit 504. A communication unit 502 communicates with the controller 210 of the image forming apparatus 110. In the communication between the image forming apparatus 110 and the inspection apparatus 120, the reception of the image data (the reference image) used for the printing, which is corresponding to the scanned image, and the transmission and reception of sheet information and inspection control information used for the printing are performed. The received reference image and inspection control information are saved in the memory unit 504. One of the inspection control information that is communicated between the image forming apparatus 110 and the inspection apparatus 120 is synchronization information for the correspondence between the scanned image and the reference image such as printing job information, printing copy information, and page order information. The other one of the inspection control information is inspection result information and control information to control an operation of the image forming apparatus 110 according to the inspection result information. The synchronization information is required in a case where the order of receiving the scanned image and the reference image used to print the scanned image by the inspection apparatus 120 is different for the two-sided printing or the printing of plural e copies. Additionally, the synchronization information is also required in a case where one reference image corresponds to plural scanned images. The inspection apparatus 120 and the finisher 130 communicate with each other and transmit and receive the inspection control information. The inspection control information communicated between the inspection apparatus 120 and the finisher 130 is the inspection result information and the control information that controls an operation of the finisher 130 according to the inspection result information.

An inspection processing unit 514 is a processing unit in which an operation thereof is controlled by the control unit 503. The inspection processing unit 514 performs the inspection determination processing on a pair of the scanned image and the reference image corresponding to each other based on the synchronization information, which is one of the inspection control information communicated with the above-described image forming apparatus 110. Details of the inspection processing unit 514 are described later. In a case where the inspection determination processing ends, a determination result is displayed on an operation unit/display unit 505. In a case where the determination result indicates that there is an image defect, the control of the image forming apparatus 110 and the finisher 130 is switched via the communication unit 502 by using a method designated by the user in advance on the operation unit/display unit 505. For example, control to stop the image forming apparatus 110 and switch a discharge tray of the finisher 130 to an escape tray is performed.

### <Internal Configuration of Inspection Processing Unit>

Next, an internal configuration of the inspection processing unit 514 is described. A skew detection unit 506 is a module that detects a skew angle of the scanned image. The scanned image is scanned so as to generate a shadow in the printed sheet end portion. The light emission device 412 for skew detection irradiates the printed sheet that is drawn in the inspection apparatus 120 and conveyed over the conveyance belt 402 with light. The shadow in the printed sheet end portion that is generated in the irradiation with light is scanned by the inspection sensor 403. This shadow is used to detect the skew angle. Based on the detected skew angle, correction processing is performed by an image correction unit 509 described later.

A color conversion unit 507 is a module that performs intermediate color conversion of the reference image. The reference image is rasterized with the CMYK color space by the image processing unit 205, and the scanned image to be inspected is read with the RGB color space by the inspection sensor 403. For this reason, it is necessary to perform the color conversion from the CMYK color space into the RGB color space; however, a read RGB value is changed greatly depending on the sheet type. In this case, the conversion into an RGB value common throughout sheets is performed, and then the conversion into an RGB value for each sheet is performed by a sheet type correspondence unit 511 described later. The RGB value common throughout sheets is, for example, data of three layers expressing each signal of RGB corresponding to sRGB that is an RGB color space independent of the printer engine with 256 gradations. Note that, sRGB in the present embodiment indicates a standard of the RGB color space established by IEC (International Electrotechnical Commission).

The color conversion unit 507 converts the reference image into an RGB image. For example, the conversion may be performed by using a CMYK to RGB look-up table as Table 1. In this case, as for a pixel on a grid point, the color conversion into RGB is performed with reference to the conversion table; however, as for a pixel that is not on the grid point, the value of RGB is obtained by interpolation from an adjacent grid point.

TABLE 1
CMYK to RGB look-up table

| C | M | Y | K | R | G | B |
|---|---|---|---|---|---|---|
| 0 | 0 | 0 | 0 | 255 | 255 | 255 |
| 31 | 0 | 0 | 0 | 230 | 240 | 255 |
| 63 | 0 | 0 | 0 | 200 | 220 | 255 |
| . | . | . | . | . | . | . |
| . | . | . | . | . | . | . |
| . | . | . | . | . | . | . |
| 255 | 255 | 255 | 255 | 0 | 0 | 0 |

A resolution conversion unit 508 is a module that performs conversion of resolutions of the scanned image and the reference image. In some cases, the scanned image and the reference image have different resolutions at a point of being inputted into the inspection apparatus control unit 405. Additionally, in some cases, the resolution used by each module of the inspection processing unit 514 and the input resolution are different from each other. In those cases, the resolution conversion is performed by the module. For example, assuming that the scanned image is at 600 DPI in main scanning/300 DPI in sub scanning, and the reference image is at 1200 DPI in main scanning/1200 DPI in sub scanning. In a case where the resolution required by the inspection processing unit 514 is 300 DPI for both the main scanning and sub scanning, each image is scaled to be contracted, and the two images are converted into an image at 300 DPI in both the main scanning and sub scanning. As a method of the scaling, a publicly known method may be used taking into consideration a calculation load and a required accuracy. For example, with the scaling using a SINC function, it is possible to obtain a scaling result at high accuracy although the calculation load is heavy. With the scaling using a nearest neighbor algorithm, a scaling result with low calculation load but at low accuracy is obtained.

The image correction unit 509 is a module that performs image correction of the scanned image and the reference image. There is a geometric difference between the scanned image and the reference image due to expansion and contraction of the paper during the printing, skew during the printing, and skew during the scanning. The image correction unit 509 corrects the geometric difference by performing the image correction based on information obtained by the skew detection unit 506 and an image-registration unit 510 described later. For example, the geometric difference is linear transformation (rotation, expansion and contraction, and shear) and parallel movement. This geometric difference can be expressed as affine transformation, and it is possible to perform the correction by obtaining an affine transformation parameter from the skew detection unit 506 and the image-registration unit 510. Note that, the information obtained from the skew detection unit 506 is only a parameter related to rotation (skew angle information).

### <Internal Configuration of Image-registration Unit 510>

The image-registration unit 510 is a module that performs the image-registration (the image position alignment) between the scanned image and the reference image. The scanned image and the reference image inputted into this module are assumed to be images having the same resolution. Note that, as the input resolution is higher, the accuracy of the image-registration is improved more, but the calculation load is heavier. With the correction being performed by the image correction unit 509 based on the parameter obtained by the image-registration, it is possible to obtain the scanned image and the reference image used by a collation unit 512 described later. The image-registration method may be various image-registration methods; however, in the present embodiment, a method of performing the image-registration of the entire image by using region information of not the entire image but a part of the image so as to reduce the calculation load. The image-registration in the present embodiment includes three steps: selecting an image-registration patch; performing the image-registration for each patch; and inferring the affine transformation parameter. Each step is described below.

First, the selection of the image-registration patch is described. In this case, the “patch” indicates a rectangular region in the image. In the selection of the image-registration patch, plural pieces of patches appropriate for the image-registration are selected from the reference image. The patch appropriate for the image-registration may be a patch with a large corner feature amount in the patch. The corner feature is a feature in which there are two conspicuous edges in different directions in the vicinity of one local (an intersection of two edges). The corner feature amount is a feature amount expressing an intensity of this edge feature. There have been invented various methods based on a difference in modelization of the “edge feature”. There is one of the methods of calculating the corner feature amount that is a publicly known method called the Harris corner detection method. In the Harris corner detection method, a corner feature amount image is calculated from a differential image in a horizontal direction (an edge feature amount image in the horizontal direction) and a differential image in a vertical direction (an edge feature amount image in the vertical direction). This corner feature amount image is an image expressing an edge amount of the one with lower intensity out of the two edges forming the corner feature. In a case where the two edges both have high intensity, the amount of the corner feature amount is expressed based on whether the edge has the edge amount with high intensity even for the edge having relatively weak corner feature. The corner feature amount image is calculated from the reference image, and a portion having a large corner feature amount is selected as the patch appropriate for the image-registration. In a case where the patches are selected simply in the descending order of a region having a larger corner feature amount, the patches may be selected from only a biased region. In such a case, there are more regions that have no patches around, and image correction information of those regions cannot be used; for this reason, it is not a state appropriate for the image-registration of the entire image. Therefore, in a case of selecting the patch, dispersed arrangement of the patches in the image is also taken into consideration, not the amount of the corner feature amount simply. Specifically, even in a case where the corner feature amount value of one patch candidate region is not a large value for the entire image, the region is selected as the patch as long as the value is large for a local region in the image. With the selection of the patch in this way, it is possible to dispersedly arrange the patches in the reference image. A parameter in a case of the patch selection may be a size of the patch and the number (or density) of the patches. As the patch is larger, and the number of the patches is larger, the accuracy of the image-registration is improved, but the calculation load is increased.

Next, the image-registration for each patch is described. In the image-registration for each patch, the image-registration is performed between the image-registration patch in the reference image that is selected as described above and the patch in the corresponding scanned image. As a result of the image-registration, two types of information are obtained. The first one is a central coordinate (refpXi, refpYi) of the image-registration patch in an i-th (i=1 to N, N is the number of the patches) reference image. The second one is the image-registration (scanpXi, scanpYi) of the central coordinate in the scanned image. The image-registration method may be any method as long as it is a shift amount inference method that can obtain a relationship between (refpXi, refpYi) and (scanpXi, scanpYi). For example, there may be a method of inferring a shift amount by using FFT to convert data of the image-registration patch and data of the corresponding patch on a frequency space and obtain a correlation on the frequency space, and the like.

Finally, inference of the affine transformation parameter is described. The affine transformation is a coordinate transformation method expressed by the following Expression (1).

$$( \begin{matrix}{x}^{′} \\ {y}^{′}\end{matrix} ) = ( \begin{matrix}a & b \\ c & d\end{matrix} ) ( \begin{matrix}x \\ y\end{matrix} ) + ( \begin{matrix}e \\ f\end{matrix} ) \qquad Expression ( 1 )$$

In the above-described Expression (1), there are six types of the affine transformation parameters, which are a, b, c, d, e, and f. Here, (x, y) corresponds to (refpXi, refpYi), and (x′, y′) corresponds to (scanpXi, scanpYi). The affine transformation parameter is inferred by using this correspondence relationship obtained from N pieces of the patches. For example, it is possible to obtain the affine transformation parameter by using the least squares method. Based on the obtained affine transformation parameter, an image after the registration correction is created by correcting the reference image or the scanned image by the image correction unit 509. Thus, it is possible to obtain a set of the reference image and the scanned image used by the collation unit 512.

### <Internal Configuration of Sheet Type Correspondence Unit 511>

The sheet type correspondence unit 511 is a module that performs processing depending on the sheet type on the reference image. Specifically, the color conversion depending on the sheet type and rotation depending on an orientation of the sheet are performed. In this module, the image processing is performed on the reference image depending on the type and the orientation of the sheet based on the inspection control information stored in the memory unit 504 in advance and the sheet information used for the printing that is transferred from the controller 210. As for the color conversion, the color conversion depending on the sheet type is performed based on the reference image converted into the RGB color space common throughout sheets by the color conversion unit 507. In the color conversion, the conversion is performed while targeting the RGB value that is read by the inspection sensor 403 for each sheet type. As the color conversion depending on the sheet type, for example, the conversion using an RGB to RGB look-up table as the following Table 2 may be applied. There may be plural look-up tables to be switched to each other depending on the sheet type.

TABLE 2
RGB to RGB look-up table

| R | G | B | R | G | B |
|---|---|---|---|---|---|
| 255 | 255 | 255 | 220 | 220 | 220 |
| 230 | 240 | 255 | 200 | 215 | 220 |
| 200 | 220 | 255 | 170 | 210 | 220 |
| . | . | . | . | . | . |
| . | . | . | . | . | . |
| . | . | . | . | . | . |
| 0 | 0 | 0 | 3 | 3 | 3 |

In addition, the sheet type correspondence unit 511 rotates the image. The image is rotated 90 degrees depending on the notified orientation of the sheet. Even with the same data, the image may be rotated depending on the orientation of the sheet stored in the sheet stocker and obtained as the scanned image. In such a case, the reference image is rotated according to the scanned image.

### <Internal Configuration of Collation Unit 512>

The collation unit 512 is a module that performs the collation between the scanned image and the reference image on which the processing is performed by sheet type correspondence unit 511. The scanned image and the reference image inputted into this module are the images having the same resolution. Additionally, in order to allow for the image comparison, the reference image or the scanned image is corrected by the image correction unit 509 based on the information obtained by the image-registration unit 510. The collation unit 512 creates a collation image by using the reference image and the scanned image. The collation processing is executed based on the parameter notified from the operation unit/display unit 505 via the control unit 503. Details of the collation processing are described later.

### <About Data Recognition Unit 513>

A data recognition unit 513 is a module that executes character recognition processing and code recognition processing on a character string inspection region and a code inspection region included in the scanned image, respectively, based on the later-described inspection setting.

### <About Operation Unit/Display Unit 505>

The operation unit/display unit 505 is a user interface in the form of a touch screen and receives setting of the processing by the inspection processing unit 514 from the user. For example, the operation unit/display unit 505 displays a setting screen and receives setting of the image processing by the inspection processing unit 514 from the user. <Control Flow of Inspection Apparatus>

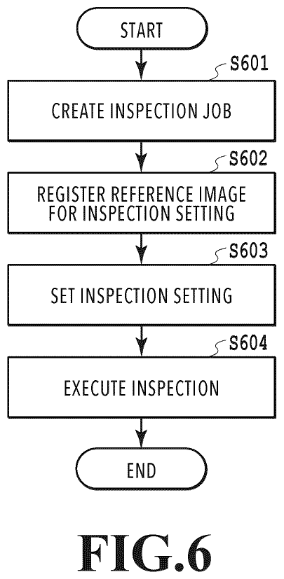

The inspection processing performed by the inspection apparatus 120 is described below with reference to FIGS. 6 to 10. Note that, all the processing and flows described with reference to those drawings are integrally executed with the control unit 503 including a computation processing device such as a CPU executing a predetermined program saved in the memory unit 504. Additionally, a result processed by each processing unit is held by the memory unit 504 and used in subsequent processing.

As illustrated in FIG. 5B, the control unit 503 includes an inspection setting unit 551 that performs various types of setting required for the inspection, a display control unit 552 that controls the operation unit/display unit 505, and a registration unit 553 that registers a specific inspection setting as a favorite (a template). The operation unit/display unit 505 displays various user interface screens. In addition, the control unit 503 also includes a determination unit 554 that determines whether the inspection setting designated as a favorite by a user operation is stored in the memory unit 504. The determination unit 554 also determines whether the character string data designated in the inspection setting designated by a user operation is already stored in the memory unit 504. Hereinafter, it is described that the control unit 503 is built in the inspection apparatus 120. That is, although it is assumed that the information processing apparatus is built in the inspection apparatus 120, it is not limited thereto. The control unit 503 may be included in the information processing apparatus as the separated body that is installed in the inspection apparatus 120. In addition, the control unit 503 may be included in the information processing apparatus arranged outside the inspection apparatus 120.

FIG. 6 is a flowchart illustrating a processing procedure of the entire inspection processing. In S601, the control unit 503 displays an inspection job management screen to create an inspection job according to activation of the inspection apparatus 120 on the operation unit/display unit 505 via the display control unit 552. In a case where a “new” button is pressed on the inspection job management screen, the processing proceeds to S602.

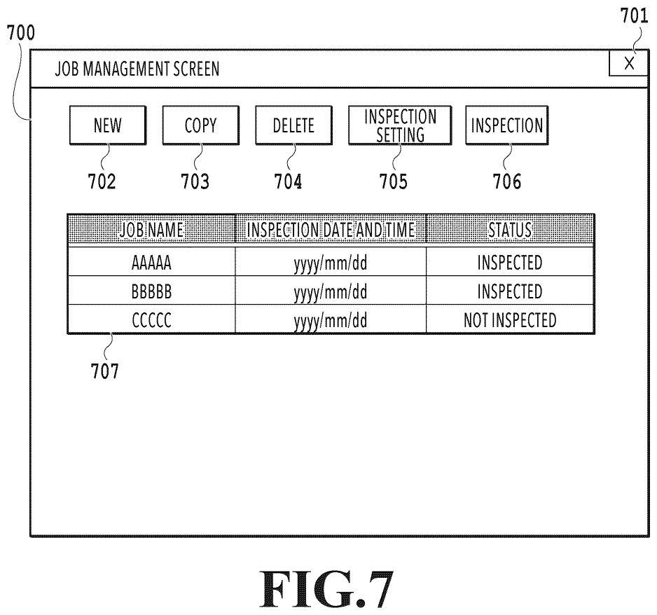

FIG. 7 is a diagram illustrating an example of an inspection job management screen 700 displayed on the operation unit/display unit 505 in S601. The inspection job management screen 700 is a screen displayed in the activation of the inspection apparatus 120, and it is possible to perform reference image registration, inspection setting, inspection execution, and copying or deleting of the created inspection job described later by the screen operation by the user. A button 701 is a button to delete display of the inspection job management screen 700. A button 702 is a button to create a new inspection job. In a case where the button 702 is pressed, the later-described reference image registration is executed.

A button 703 is a button to copy the inspection job already created. In a case where the button 703 is pressed, the inspection job selected from inspection jobs displayed on an inspection job list 707 is copied. With the copying, it is possible to execute the new inspection by copying the reference image or the inspection setting. A button 704 is a delete button. In a case where the button 704 is pressed, the inspection job selected from the inspection jobs displayed on the inspection job list 707 is deleted. In this process, it is also possible to delete plural inspection jobs at one time by selecting the plural inspection jobs and pressing the button 704.

A button 705 is an inspection setting button. In a case where the button 705 is pressed, the later-described inspection setting is executed. A button 706 is an inspection execution button. In a case where the button 706 is pressed, the inspection is executed on the inspection job on which the later-described reference image registration and inspection setting are completed.

Referring back to FIG. 6. Next, in S602, the control unit 503 registers a reference image for the inspection setting that is selected by the user via the registration unit 553. Specifically, reading of the reference image is started by the inspection apparatus 120 in advance, and the client PC executes a printing job for the reference image registration used for the inspection setting in S603. Note that, although a read image obtained by reading the printed sheet is used as the reference image in this case, it is not limited thereto. As for the reference image, an RIP image received by the inspection apparatus 120 may be registered as the reference image. In a case where the reference image for the inspection setting is registered, the processing proceeds to S603.

In S603, the control unit 503 receives the inspection setting by the user via the inspection setting unit 551. In the inspection setting, setting of the various inspection parameters, inspection regions, and inspection levels are performed. Details are described later. In a case where the processing of the inspection setting is completed, the processing proceeds to S604. In S604, in a case where the button 706 (the “inspection” button) is pressed on the inspection job management screen 700 by the user, the control unit 503 starts the inspection by the inspection apparatus 120 and executes the printing job for the inspection by the client PC. In a case where the printing is executed, the inspection apparatus 120 detects the conveyance of the printed sheet and scans the printed sheet by the inspection sensor 403. The scanned image is saved in the memory unit 504. The saved image is compared with the reference image, and an inspection result is outputted. The inspection is executed based on a setting value designated by the user by the inspection setting in S603. In a case where the inspection is completed, the processing flow in the flowchart illustrated in FIG. 6 ends.

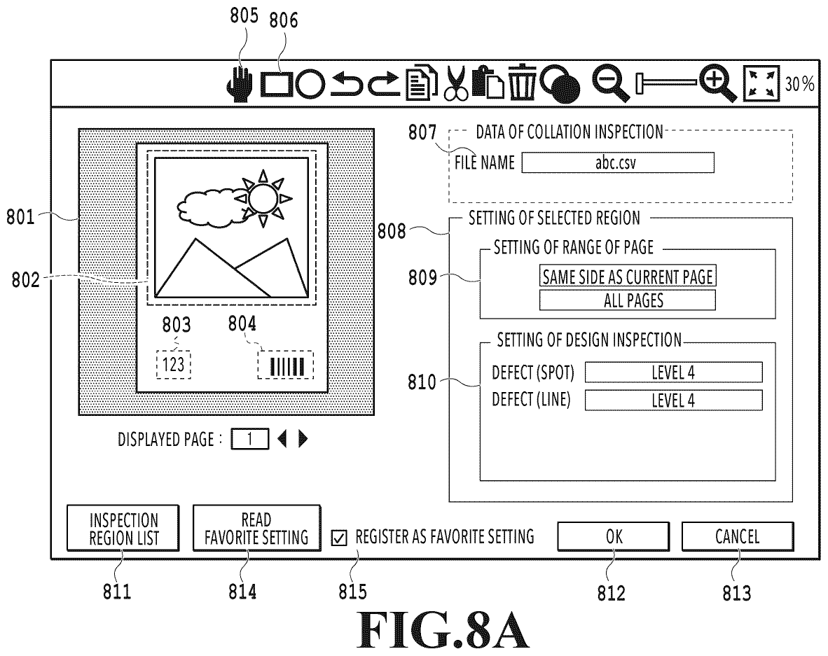

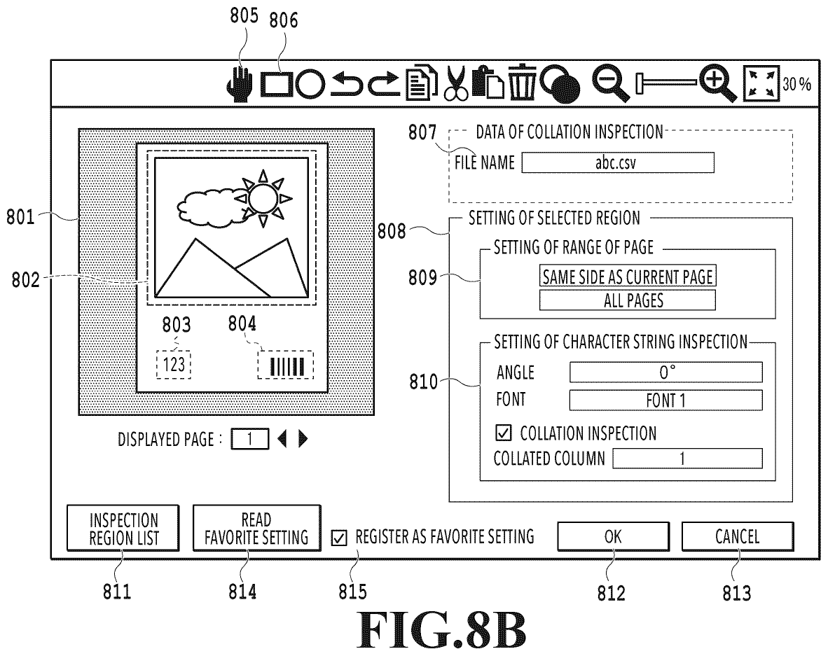

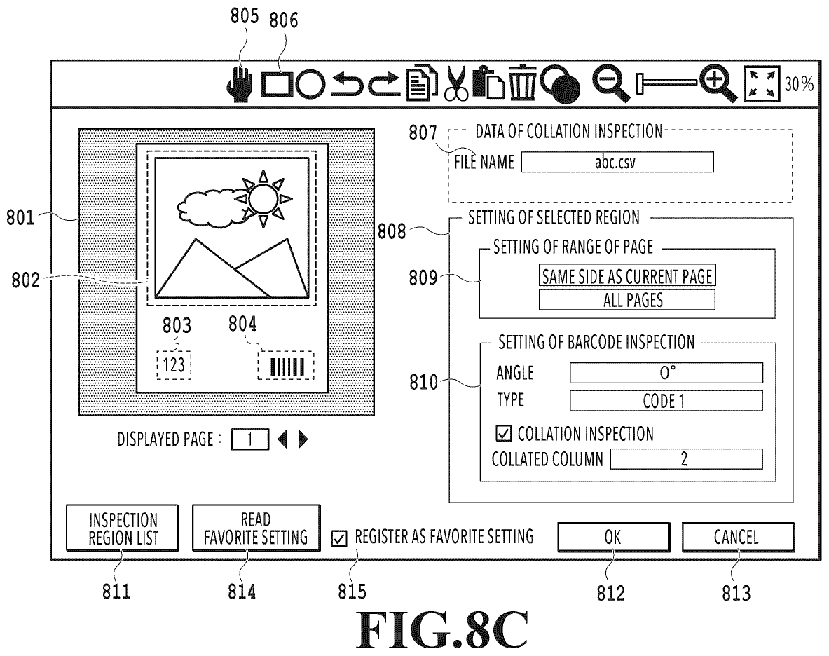

Next, details of the inspection setting described in the section of S603 are described with reference to FIGS. 8A, 8B, 8C, 9, and 10. The selection of the reference image registered by the user in S602 on the operation unit/display unit 505 is a trigger to start the processing of the inspection setting.

FIGS. 8A to 8C are an example of the inspection setting screen to receive an operation to execute the inspection setting from the user. The inspection setting screen is displayed on the operation unit/display unit 505. The user arranges the inspection region on a preview of the reference image for the inspection setting that is displayed on the inspection setting screen and additionally performs detailed inspection setting on each inspection region arranged on the preview.

A region 801 is a preview display screen on which the reference image for the inspection setting is displayed. In a case where there is an instruction to print plural pages in the printing job, the display control unit 552 receives a user operation to switch pages of the reference image for the inspection setting displayed as a preview. Thus, the operation unit/display unit 505 can display the reference image on each page. A region 802 to a region 804 are frames indicating the inspection regions arranged on the preview. The inspection region is arranged by an inspection region arrangement button 806 described later, and it is possible to change the region information such as the size, the position, and the like of the inspection region by a drag operation by the user. The region 802 indicates an example in which a design inspection region is arranged. The region 803 indicates an example in which a character string inspection region is arranged. The region 804 indicates an example in which a code inspection region for a barcode and the like is arranged.

In a case where the user presses an inspection region selection button 805, the user clicks or taps the regions 802 to 804 indicating the inspection regions, and the control unit 503 receives the operation to select the inspection region from the user. In a case where the user presses the inspection region arrangement button 806, the user can select a type of the inspection region from a pull-down menu and can arrange the inspection region of the selected type on the preview display by a drag operation.

A setting item 807 is a setting item to allow the user to select correct character string data used for the data collation inspection such as the above-described character string inspection and code inspection by a file selection system. In this case, the correct character string data means, for example, a data file including character string information in a CSV file format that indicates a correct answer such as a store name in a case where the printed product is a flyer of a supermarket. This reference CSV file is prepared in advance by the user. In the data collation inspection, the control unit 503 extracts the region corresponding to the character string and/or the code that is the target of the data collation inspection from the scanned image obtained by reading the printed sheet. Then, the control unit 503 collates the character string obtained by analyzing the region (an OCR result or a decoding result) with the correct character string indicated by the reference CSV file.

A setting item 808 indicates a detailed setting value of the inspection region being selected. The setting value includes the setting value used in the design inspection and the data collation inspection. The setting value of the inspection region selected by the inspection region selection button 805 is displayed. A setting item 809 is a setting item of a range of the page. In a case where the user presses each button in the setting item 809, the display control unit 552 receives “setting of range of page” for the inspection region being selected. In a case where nothing is set to “range of page”, the inspection region being selected is arranged on only the page currently displayed on the preview display screen. In a case where “same side as current page” is selected as “range of page”, according to whether the inspection region being selected is arranged on the front side or the back side of the sheet, the inspection region being selected is arranged on the same side of the page. In a case where “all pages” is selected as “range of page”, the inspection region being selected is arranged on all the pages. In this process, if “range of page” is changed to “all pages”, the inspection region on one page does not match the region that the user wants to set as the inspection target in some cases. In a case where the above-described state occurs, the user corrects the position of the inspection region with reference to the preview display screen with visual confirmation such that the inspection region is arranged in a desired position.

A setting item 810 displays the setting item according to a type of the inspection selected by the inspection region selection button 805. The setting item illustrated in FIG. 8A is a setting item of the design inspection that is displayed in a case where the region 802 indicating the design inspection region is selected. The setting item of the design inspection includes an item to set the type of defect to be inspected, a level of detection indicating how fine the defect can be detected, and the like in the inspection of the printed product. The inspection item is, for example, a circular shape defect (spot) and a linear defect (line). The inspection level is, for example, five levels from a level 1 to a level 5, and it is possible to detect the defect in smaller size at the level 5 than at the level 1. Additionally, it is possible to set the level for each inspection item so that the spot is inspected at the inspection level 5 while the line is inspected at the inspection level 4.

The setting item illustrated in FIG. 8B is a setting item of the character string inspection that is displayed in a case where the region 803 indicating the character string inspection region is selected. For each inspection region, an angle of the inspection region, a font of the character string, whether to execute the data collation inspection, and which column in the reference CSV file to collate with in a case of executing the data collation inspection are set. Additionally, an item to select the font of the character string is displayed, and the selection of the font is received from the user. In the present embodiment, the file in which the correct character string of the data collation inspection is written is the reference CSV file; however, it is not limited thereto. The file in which the correct character string of the data collation inspection is written may be, for example, a text file in which one correct character string is written in one row.

The setting item illustrated in FIG. 8C is a setting item of the code inspection that is displayed in a case where the region 804 indicating the code inspection region is selected. In FIG. 8C, the setting item of the barcode inspection is displayed as an example. For each inspection region, the angle of the inspection region, a type of the code, whether to execute the collation inspection, and which column in the reference CSV file to collate with in a case of executing the collation inspection are set. Additionally, the type of the code includes a two-dimensional code in addition to the barcode.

Note that, although displaying of an item having no relation is prevented by displaying the setting item according to the type of the selected inspection region in the present embodiment, it is not limited thereto. For example, the item having no relation may be invalidated by displaying all the items, or the item having no relation may be collapsed so as not to be displayed.

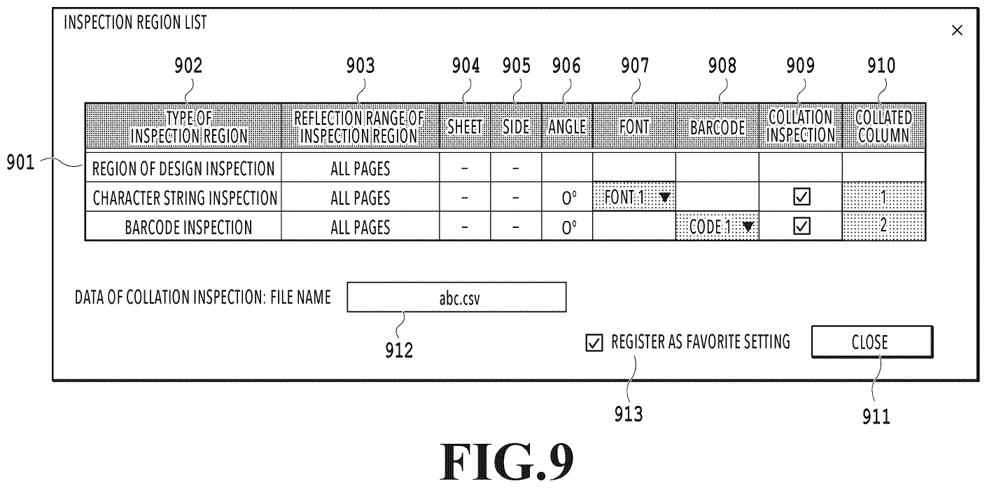

A button 811 is a display button of an inspection region list. In a case where the user presses the button 811, the inspection region list illustrated in FIG. 9 is displayed. A button 812 is an inspection setting completion button. In a case where the user presses the button 812, the inspection setting processing ends, and the control unit 503 saves the designated inspection setting in the memory unit 504 and ends the inspection setting processing. The button 812 may be invalidated in a case where the inspection setting is inconsistent. The case where the inspection setting is inconsistent may include, for example, a case where the setting item 807 of the data for the collation inspection is not set although there is the inspection region on which the collation inspection is executed.

A button 813 is a cancel button of the inspection setting. In a case where the user presses the button 813, the designated inspection setting is discarded, and the inspection setting processing ends. A button 814 is a button to read the inspection setting that is registered as a favorite, which is described later. In a case where the user presses the button 814, the control unit 503 displays a selection screen of the inspection setting registered as a favorite on the operation unit/display unit 505 via the display control unit 552. A checkbox 815 is a checkbox for the user to instruct whether to register the inspection setting currently set as the favorite setting. In a case where the user completes the inspection setting in a state in which the checkbox 815 is checked and presses the button 812, the inspection setting being set is registered as the favorite setting according to the later-described processing flow.

FIG. 9 is an example of an inspection region list screen that is displayed on the operation unit/display unit 505 to display the list of the inspection regions currently set and receive an operation to change the inspection setting from the user. Each row in the list corresponds to each of the regions 802 to 804 indicating the arranged inspection regions. The items set in the setting items 809 and 810 correspond to display fields 905 to 909. The user can confirm and change the setting value by selecting the inspection region one by one on the inspection setting screen; however, the operation to confirm the setting of the plural inspection regions takes so much time. On the other hand, the inspection region list screen illustrated in FIG. 9 can change the setting value while confirming the setting values of the plural inspection regions all at once. In a case where the user presses the button 811 to display the inspection region list screen, the inspection region list screen is displayed on the operation unit/display unit 505. In the present embodiment, it is assumed that the inspection region list screen is displayed as a floating window different from the inspection setting screen; however, the inspection region list screen may be displayed as a transition from the inspection setting screen.

A display field 901 is a row displaying the setting value of each inspection region. In a case where the user clicks or taps the row that the user wants to select, the selection of the row is received. Copying or deleting of the selected inspection region may be received by opening a context menu by an operation such as right click. A display field 902 is a display field of the type of the inspection region. A display field 903 is a display field of the setting of the range of the page of the inspection region. The inspection region list screen has no preview function. Accordingly, no operation to set the range of the page is received from the inspection region list screen. A display field 904 is a display field of the sheet on which the inspection region is arranged. The display field 905 is a display field of the side (surface) on which the inspection region is arranged. The display field 906 is a display field of the setting of the angle of the inspection region. In the present embodiment, as for the angle, the setting value of the angle is also determined while confirming the state on the preview screen as with the inspection region. Accordingly, no operation to set the angle is received from the inspection region list screen having no preview function.

The display field 907 is a display field of the setting of the font of the inspection region. The user can perform an operation to change the font in the display field 907. The display field 908 is a display field of the setting of the type of the barcode of the inspection region. The user can perform an operation to change the type of the barcode in the display field 908. In FIG. 9, the barcode is used as an example; however, another code such as a two-dimensional code may be received. The display field 909 is a display field of the setting to determine whether to execute the data collation inspection of the inspection region. The user can perform an operation to change the setting to determine whether to execute the data collation inspection for each row of the display field 901. A display field 910 is a display field of the setting to determine which column in the reference CSV file to collate with the inspection region.

A button 911 is a button to end the displaying of the inspection region list screen, and in a case where pressing of the button 911 is received, the display control unit 552 ends the displaying of the inspection region list screen. A display field 912 displays a file name of the reference CSV file used for the data collation inspection. A checkbox 913 is a checkbox to determine whether to save the inspection setting displayed on the inspection region list as favorite setting. In a case where the user presses the button 911 in a state in which the checkbox 913 is checked, the displaying of the inspection region list screen ends, and thereafter the control unit 503 displays a setting screen of a favorite registration name, which is described later, via the display control unit 552. Note that, the inspection setting that can be registered as the favorite setting includes the reference image data and the coordinate information of each inspection region that are used for the inspection in addition to each setting described from the display fields 902 to 910 and the display field 912.

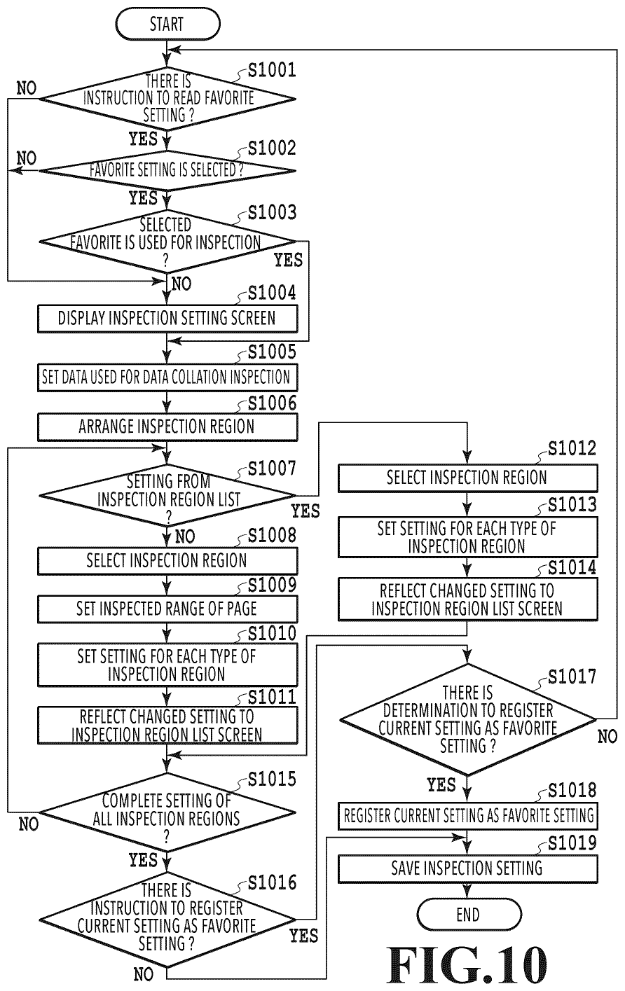

FIG. 10 is a flowchart illustrating a processing procedure in the inspection apparatus 120 in a case where an operation to start the inspection setting is performed on the inspection apparatus 120. In a case where the operation is received from the inspection setting screen and the inspection region list displayed on the operation unit/display unit 505 of the inspection apparatus 120, the control unit 503 of the inspection apparatus 120 executes various types of processing to perform the inspection setting. The various types of processing to perform the inspection setting are implemented with the control unit 503 in a CPU 221 of the inspection apparatus 120 executing a predetermined program corresponding to the flowchart in FIG. 10.

In S1001, the control unit 503 determines whether an instruction to read the setting already registered as the favorite setting is received from the user. The determination on whether the reading instruction is received is determined based on whether the button 814 is pressed. In a case where the button 814 is pressed (S1001 is Yes), the processing proceeds to S1002. In a case where the button 814 is not pressed (S1001 is No), the processing proceeds to S1004.

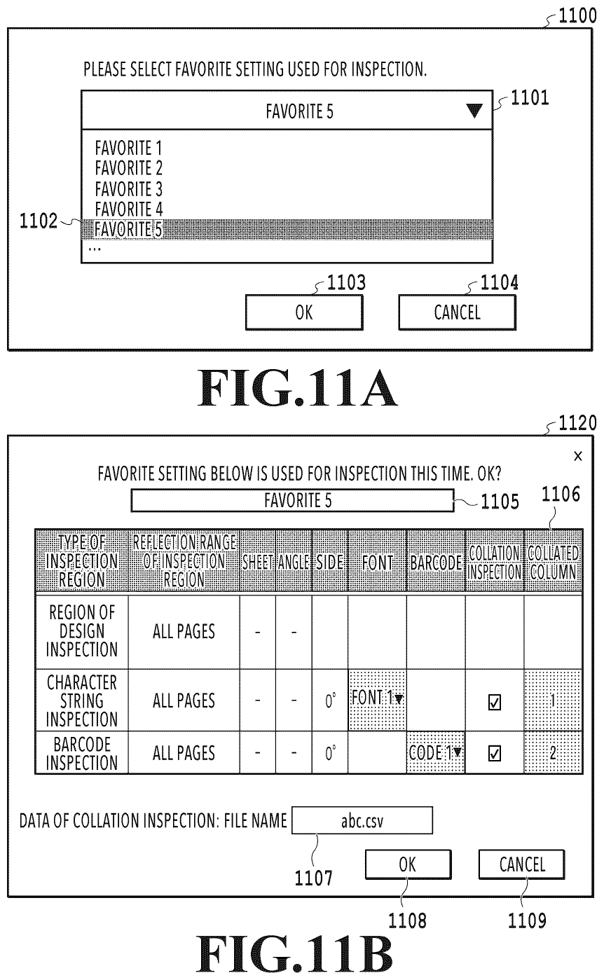

In S1002, the control unit 503 displays a screen to allow the user to select the favorite setting from the setting already registered as the favorite setting and determines whether the favorite setting is selected. FIG. 11A is a diagram illustrating an example in which the control unit 503 displays a screen 1100 to select the favorite setting used for the inspection from the setting already registered as the favorite setting on the operation unit/display unit 505 via the display control unit 552 in S1002.

A setting field 1101 is a box to temporarily display the favorite setting selected by the user. With the user pressing the setting field 1101, a list of the favorite setting already registered before then is displayed as a pull-down menu under the box. The user can select the favorite setting used for the inspection from the above. A display field 1102 indicates the favorite setting selected by the user from the already registered favorite setting displayed in the pull-down menu described above and displays the favorite setting selected by the user with highlight. In FIG. 11A, a state in which the favorite setting having a name “favorite 5” is selected by the user is illustrated.

A button 1103 is a button to determine the favorite setting used for the inspection. In a case where the user presses the button 1103, the screen transitions to a confirmation screen of the favorite setting described later in FIG. 11B, and the processing proceeds to S1003. A button 1104 is a button to cancel the selection of the favorite setting used for the inspection. In a case where the user presses the button 1104, the processing proceeds to S1004.

In S1003, the control unit 503 displays a favorite setting confirmation screen 1120 illustrated in FIG. 11B via the display control unit 552. In FIG. 11B, a display field 1105 is a box indicating the favorite setting name determined by the user. A display field 1106 is a table specifically indicating the favorite setting used for the inspection, and contents indicated by the table are the same as that in the inspection setting list described with reference to FIG. 9. A display field 1107 is the file name of the reference CSV file included in the favorite setting. A button 1108 is a button to determine that the selected favorite setting is used for the inspection. In a case where the user presses the button 1108, the control unit 503 determines the selected favorite setting as the favorite setting used for the inspection, and the processing proceeds to S1005. A button 1109 is a button to cancel the selection of the favorite setting used for the inspection as with the button 1104. In a case where the user presses the button 1104, the processing proceeds to S1004. In S1004, the control unit 503 displays the inspection setting screen reflecting the inspection setting at a point of S1001 via the display control unit 552 on the operation unit/display unit 505, and the processing proceeds to S1005.

In S1005, the control unit 503 receives an operation to set the reference CSV file used for the data collation inspection from the inspection setting screen. In the present embodiment, it is possible to change the reference CSV file even in a case where the control unit 503 reads the favorite setting in S1003 described above and reflects the setting to the inspection setting screen. In S1006, the control unit 503 receives an operation to arrange the inspection region from the inspection setting screen. In the present embodiment, the operation to arrange the inspection region is performed by operating the inspection region arrangement button 806 by the user.

In S1007, the control unit 503 determines whether the individual setting of the inspection region by the user is performed from the inspection setting screen or from the inspection region list screen. In a case where the setting is performed from the inspection setting screen, the processing proceeds to S1008, and processing from S1008 to S1011 is performed. In a case where the setting is performed from the inspection region list screen, the processing proceeds to S1012, and the processing from S1012 to S1014 is performed.

In S1008, the control unit 503 received an operation to select the inspection region from the inspection setting screen. In the present embodiment, the operation to select the inspection region is performed by operating the inspection region selection button 805 displayed on the operation unit/display unit 505 by the user. In S1009, the control unit 503 receives an operation to set the range of the page from the inspection setting screen. In the present embodiment, the operation to set the range of the page is performed by operating the setting item 809 of the range of the page that is displayed on the operation unit/display unit 505 by the user.

In S1010, the control unit 503 receives a setting operation for each type of the inspection region from the inspection setting screen. In the present embodiment, the setting operation for each inspection region is performed by operating the setting item 810 for each type of the inspection region that is displayed on the operation unit/display unit 505 by the user. In S1011, the control unit 503 reflects a result of the setting operation performed on the inspection setting screen by the user onto the inspection region list screen to synchronize the display contents. In a case where the display contents are synchronized, the processing proceeds to S1015.

Next, processing from S1012 to S1014 in a case where the setting is performed from the inspection region list screen is described. The inspection region list screen illustrated in FIG. 9 has no preview. Since it is impossible to visually confirm the designated arrangement on the inspection region list screen, no operation to set the range of the page is received on the inspection region list screen.

In S1012, the control unit 503 receives an operation to select the inspection region from the inspection region list screen. In the present embodiment, the operation to select the inspection region is performed by operating the display field 901 displayed on the operation unit/display unit 505 by the user. In S1013, the control unit 503 receives a setting operation for each type of the inspection region from the inspection region list screen. In the present embodiment, the operation to set each inspection region is performed by operating the display fields 907 to 910 of each setting value that are displayed on the operation unit/display unit 505 by the user. In S1014, the control unit 503 reflects a result of the setting operation performed on the inspection region list screen by the user onto the inspection setting screen to synchronize the display contents. In a case where the display contents are synchronized, the processing proceeds to S1015.

In S1015, the control unit 503 determines whether the inspection setting by the user is completed. In a case where the control unit 503 determines that the inspection setting is completed, the user presses the button 812, and the processing proceeds to S1016. In a case where the control unit 503 determines that the inspection setting is not completed, the user performs the operation to select the inspection region in S1007 and continues the inspection setting processing.

In S1016, the control unit 503 determines whether there is an instruction from the user to register the inspection setting in which the setting by the user is completed in S1015 as the favorite setting. This determination is performed depending on whether the checkbox 815 is checked. In other words, in a case where the checkbox 815 is checked (S1016 is Yes), the processing proceeds to S1017. In a case where the checkbox 815 is not checked (S1012 is No), the processing proceeds to S1019.

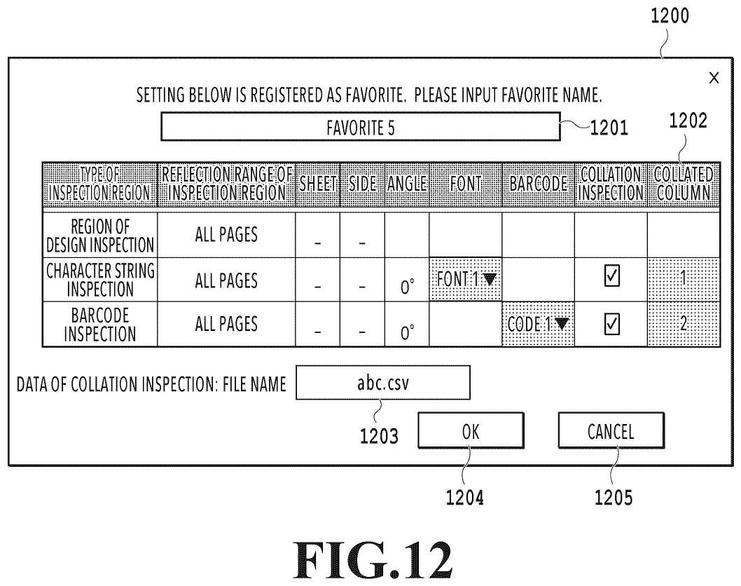

In S1017, first, the control unit 503 displays a confirmation screen of the setting to be registered as a favorite on the operation unit/display unit 505. FIG. 12 is a diagram describing a favorite setting registration confirmation screen 1200 displayed on the operation unit/display unit 505 in S1017. A setting field 1201 is a text box to set the name of the favorite setting to be registered. The user can input the name of the favorite setting to be registered into the text box on the operation unit/display unit 505.

A display field 1202 is a table that lists and displays the favorite setting to be registered. The inspection setting listed and displayed herein is the setting determined in S1015. The format of the table is the same as that described with reference to FIG. 9, and each column is also the same as that described for the display field 901 to the display field 910. A display field 1203 is a box to display the file name of the reference CSV file for the data collation inspection in the favorite setting to be registered. Note that, in these display field 1202 and display field 1203, the inspection setting is already determined in S1015. Therefore, unlike the operation on the inspection setting list screen described with reference to FIG. 9, it is impossible to change each inspection setting and the setting of the reference CSV file.

A button 1204 is a button to determine the registration as the favorite setting, and it is possible to determine the favorite registration with the user pressing the button 1204. A button 1205 is a button to cancel the registration as the favorite setting, and it is possible to cancel the favorite registration and perform the inspection setting again with the user pressing the button 1205.

Referring back to S1017. The control unit 503 determines whether an instruction of the registration as the favorite setting by the user is determined. The determination is determined depending on whether the button 1204 or the button 1205 described above is pressed. In a case where the button 1204 is pressed (S1017 is Yes), the control unit 503 determines that the registration instruction is determined, and the processing proceeds to S1018. On the other hand, in a case where the button 1205 is pressed (S1017 is No), the control unit 503 determines that the registration instruction is canceled, and the processing returns to S1001.

In S1018, the control unit 503 saves the favorite setting (template) determined in S1017 in the memory unit 504, and the processing proceeds to S1019. In S1019, the control unit 503 saves the inspection setting used in the inspection job that is determined in S1015 in the memory unit 504 and ends the processing flow of the flowchart illustrated in FIG. 10. Note that, in a case where the favorite setting already registered in S1002 to S1004 is read and set in the processing flow described in FIG. 10, the processing may be performed as below. For example, it is also possible to determine the inspection setting used in the inspection job and save the determined inspection setting in the memory unit 504 in S1019 without executing the processing from S1005 to S1018 after S1004.

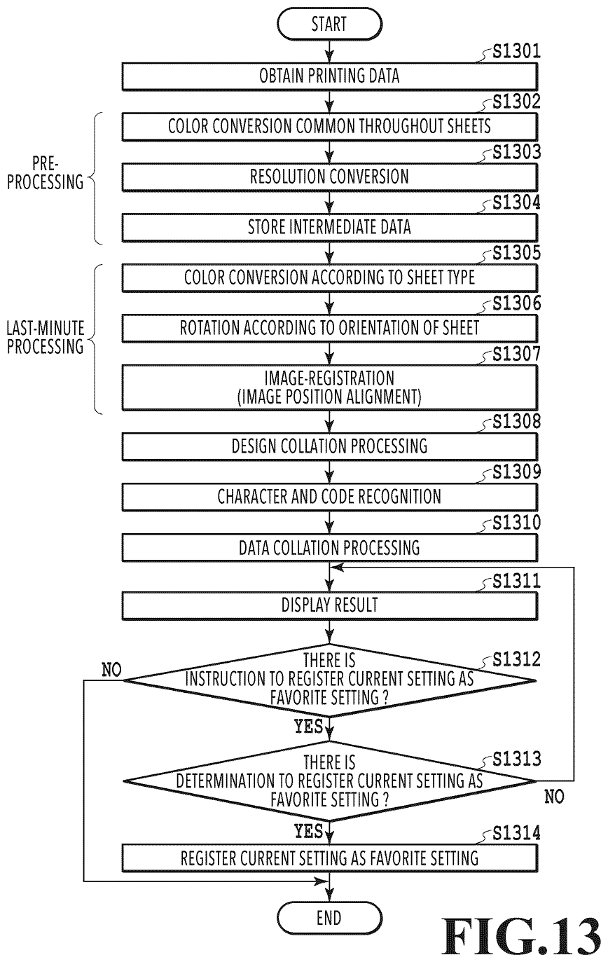

FIG. 13 is a flowchart illustrating a detailed processing procedure of the inspection execution processing described above in S604 in FIG. 6. The inspection execution processing is implemented with the control unit 503 and the inspection processing unit 514 in the CPU 221 of the inspection apparatus 120 executing a predetermined program corresponding to the flowchart in FIG. 13.

In S1301, the control unit 503 obtains the data used for the printing via the communication unit 502 and stores the data in the memory unit 504. Next, the control unit 503 performs pre-processing from S1302 to S1304. The control unit 503 performs the processing on the reference image by using the reference image received from the image forming apparatus 110 that is held in the memory unit 504 via the communication unit 502. The processing is processing independent of the sheet, and a processing result is stored in the memory unit 504 again.

In S1302, the control unit 503 performs the color conversion on the reference image. The reference image is color-converted into the color space common throughout sheets by the color conversion unit 507, and the processing proceeds to S1303. In S1303, the control unit 503 performs the resolution conversion on the reference image. The resolution conversion unit 508 converts the resolution of the reference image as the processing target into a resolution required for the inspection. In a case where the resolution conversion is completed, the processing proceeds to S1304.

In S1304, the control unit 503 stores the reference image in which the resolution is converted in the memory unit 504 with an ID. The ID is included in the inspection control information and may be anything as long as it can determine the reference image uniquely. For example, the ID may be a character string formed of numbers such as “202208010001”. The inputted reference image is assumed to be the CMYK image at 1200 DPI in main scanning/1200 DPI in sub scanning. With the pre-processing, the reference image is converted into the RGB image at 300 DPI in both the main scanning and sub scanning, and the image size is reduced considerably. Specifically, the resolution is reduced to 1/16, and the channel number is reduced by one channel. Therefore, it is possible to make the capacity of the memory unit 504 small.

Next, in S1305 to S1307, the control unit 503 performs last-minute processing on the reference image to make the reference image as an image that can be compared with the scanned image (an inspection image). The control unit 503 selects an image pair of the scanned image and the reference image that should be processed by using the inspection control information received from the image forming apparatus 110 that is held in the memory unit 504 by way of the communication unit 502. In this process, as for the reference image, the corresponding reference image is obtained from the memory unit 504 from the ID written in the inspection control information. Then, the color conversion according to the sheet is performed such that the scanned image and the reference image can be compared based on the information of the sheet used for the printing that is transferred from the controller 210. In the information of the sheet used for the printing in this case, the type and the orientation of the sheet are not determined until the printing job is executed; for this reason, the sheet information is notified after the printing job is executed.

In S1305, the control unit 503 performs the color conversion processing according to the sheet type by the sheet type correspondence unit 511. The reference image converted into the color space common throughout sheets in S1302 is converted into the color space read by the inspection sensor 403 according to the sheet type. Thus, the conversion allows for the accurate collation determination. In S1306, the control unit 503 rotates the image according to the orientation of the sheet by the sheet type correspondence unit 511. The orientation of the sheet is obtained from the inspection control information, and the image is rotated to match the orientation of the scanned image.

In S1307, the control unit 503 performs the image-registration of both the scanned image and reference image by using those images obtained in S1301. The image-registration unit 510 executes the processing by using the scanned image and the reference image, and the image-registration unit 510 obtains the affine transformation parameter. Then, the image correction unit 509 performs the correction processing of the reference image by using the affine transformation parameter obtained from the image-registration unit 510, makes a coordinate system the same as that of the scanned image, and makes the reference image as an image that can be used for the collation.

In S1308, the control unit 503 performs the collation processing of the design by using the scanned image and the reference image obtained in S1307. First, the control unit 503 executes the processing on the scanned image and the reference image by the collation unit 512. In S1309, based on the inspection setting designated in S603, the control unit 503 executes the character string recognition processing on the region 803 (the character string inspection region) and executes the code recognition processing on the region 804 (the code inspection region). A recognition result is held in the memory unit 504 in association with the inspection region as the recognition target.

In S1310, the control unit 503 collates the correct character string corresponding to each inspection region that is written in the reference CSV described above in the description of the setting item 807 with the recognition data held in the memory unit 504 in S1309. In S1311, the control unit 503 displays an inspection processing result on the operation unit/display unit 505.

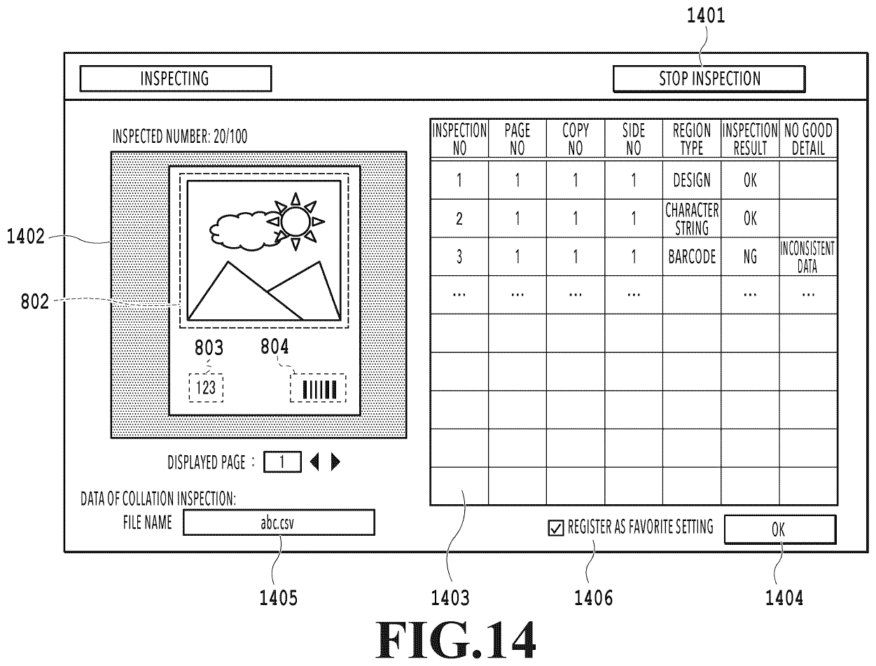

FIG. 14 is a diagram illustrating an example of the inspection result display in S1311. The inspection result display illustrated in FIG. 14 is displayed on the operation unit/display unit 505. A button 1401 is an inspection stop button. In a case where the user presses the button 1401, the inspection job currently executed by the control unit 503 is stopped. A region 1402 is an inspection region display in which the inspection region of the scanned image (inspection image) currently selected can be displayed as a preview.

A display field 1403 is an inspection result table indicating the inspection result list of the executed inspection. There are displayed information to determine the inspection region uniquely, which is for example “inspection NO” indicating which inspection region in the page, “page NO” indicating which page, “copy NO” indicating which copy, and “side NO” indicating back or front. In addition, there are displayed information indicating which inspection type the inspection region is, either the design inspection or the data collation inspection (character string or barcode), the inspection result of the inspection region for each inspection type, and a detailed cause of a case where the inspection result is No Good. In this case, the inspection results of the corresponding inspection regions that are described with reference to FIG. 9 are displayed in the inspections NO1 to NO3. Additionally, since the inspection result of the region 804 (the code inspection region) corresponding to NO3 is inconsistent data between the correct data written in the reference CSV file and the recognition result in S1309, it is indicated that the inspection is No Good.

A button 1404 is a completion button of the inspection processing. In a case where the user presses the button 1404, the control unit 503 saves the inspection result in the memory unit 504, and the inspection processing ends. A display field 1405 is a box indicating the file name of the reference CSV file used for the inspection. Note that, since the reference CSV file displayed in the display field 1405 indicates the file already used for the inspection processing, it is impossible to change the reference CSV file on this screen.

A checkbox 1406 is a checkbox to allow the user to instruct whether to register the inspection setting used for the inspection as the favorite setting. In a case where the user presses the button 1404 to complete the inspection processing in a state in which the checkbox is checked, the inspection setting is registered as the favorite setting according to the processing flow described later with reference to FIG. 13.

Referring back to FIG. 13. In the subsequent S1312, the control unit 503 determines whether there is the instruction from the user to register the inspection setting used in the inspection job that is displayed as a result in S1311 as the favorite setting. This determination is performed based on whether the checkbox 1406 of the favorite registration is checked. In other words, in a case where the checkbox 1406 is checked (S1312 is Yes), the processing proceeds to S1313. In a case where the checkbox 1406 is not checked (S1312 is No), the processing flow illustrated in FIG. 13 ends.

In S1313, the control unit 503 displays the favorite setting registration confirmation screen 1200 with reference to FIG. 12. Next, the control unit 503 determines whether the registration of the favorite setting is determined on the displayed registration confirmation screen 1200. The determination is determined based on whether either the button 1204 or the button 1205 described above is pressed. In a case where the button 1204 is pressed (S1313 is Yes), the control unit 503 determines that the registration instruction is determined, and the processing proceeds to S1314. On the other hand, in a case where the button 1205 is pressed (S1313 is No), the control unit 503 determines that the registration instruction is canceled, and the processing returns to S1311. Note that, the processing in a case where S1313 is No may not be the return to S1311 as described above, and the processing flow illustrated in FIG. 13 may end without performing the registration as the favorite setting. In S1314, the control unit 503 saves the favorite setting (template) determined in S1313 in the memory unit 504, and the processing flow illustrated in FIG. 13 ends.

With the present embodiment being executed with the above-described configuration, it is possible to register the inspection setting used in the inspection job as the favorite inspection setting in any of the timings, which are the creation of a new inspection job, the copying of the inspection job, the determination of the inspection setting, and the result confirmation after the inspection execution. Additionally, in a case where the registered favorite inspection setting is applied to the subsequent inspection job, it is possible to change and set the reference CSV file of the collation data used for the data collation inspection from that in the favorite registration. With the control of the inspection apparatus 120 in this way, it is possible to perform the inspection setting of the printed product easily and simply in a case where the printing data of the inspection target is the same as that in the favorite registration. In addition, in a case where the layout of the printing data is the same as that in the favorite registration but the data of the data collation inspection target is different, it is also possible to perform the inspection by changing only the reference CSV file.

Moreover, in a case where the reference CSV file set as the favorite is different from the reference CSV file used in the inspection job, a candidate of the reference CSV file may be displayed by a pull-down menu. It is possible to select the reference CSV file corresponding to the inspection job from the reference CSV file displayed on the pull-down menu by a user operation. Additionally, contents of the reference CSV file selected from the pull-down menu may be displayed on the operation unit/display unit 505. The user can confirm the contents of the selected reference CSV file, and it is possible to surely select the reference CSV file corresponding to the inspection job. Moreover, in a case where there is no reference CSV file used in the inspection job in the reference CSV file stored in the memory unit 504, the control unit 503 may display a message indicating that “there is no corresponding reference CSV file” on the operation unit/display unit 505.

In the present embodiment, the descriptions are provided assuming that the designs are the same; however, it is merely an example. Even in a case where the designs are different, the present embodiment is applicable. That is, the template in which the details of the inspection setting are set is created while targeting only the data collation inspection. It is also possible to execute the data collation inspection by using this template. In this case, it is also possible to select the reference CSV file corresponding to the inspection job as needed and to change the setting of the template easily. Accordingly, it is possible to improve the usability in a case of the inspection setting of the inspection using the template.

### Modification of First Embodiment

A modification related to the registration processing of the favorite setting described by using from S1017 to S1018, from S1313 to S1314, and FIG. 12 in the first embodiment is described.

As the modification, in a case where there is the already registered favorite setting that is the same as the favorite setting that is instructed to be registered in S1018 or S1314, it is possible to control so as not to perform the favorite registration with a new name. The determination on whether the favorite setting is the same is performed by the control unit 503 comparing the inspection setting registered and instructed in S1018 or S1314 via the determination unit 554 to each of the favorite settings already registered to see whether the included inspection settings are all the same. With the present disclosure being executed as described above, it is possible to control so as not to register the plural favorite settings formed of the same inspection settings. Accordingly, it is possible to improve the usability in a case where the setting of the inspection using the template.

### Second Embodiment

Here is described, with reference to the drawings, the possibility to select the reference CSV file used for the collation inspection further easily and simply in addition to the effects described in the first embodiment with appropriate execution of the present disclosure. Specifically, the possibility to select the corresponding reference CSV file even in a case where the layout is the same as that of the reference image data included in the already registered favorite setting but the data printed in each region as the target of the collation inspection is different is described. Note that, in the description of the present embodiment, description of a portion in which the configuration and the processing procedure are the same as that in the first embodiment is omitted, and only a portion having a difference is described.

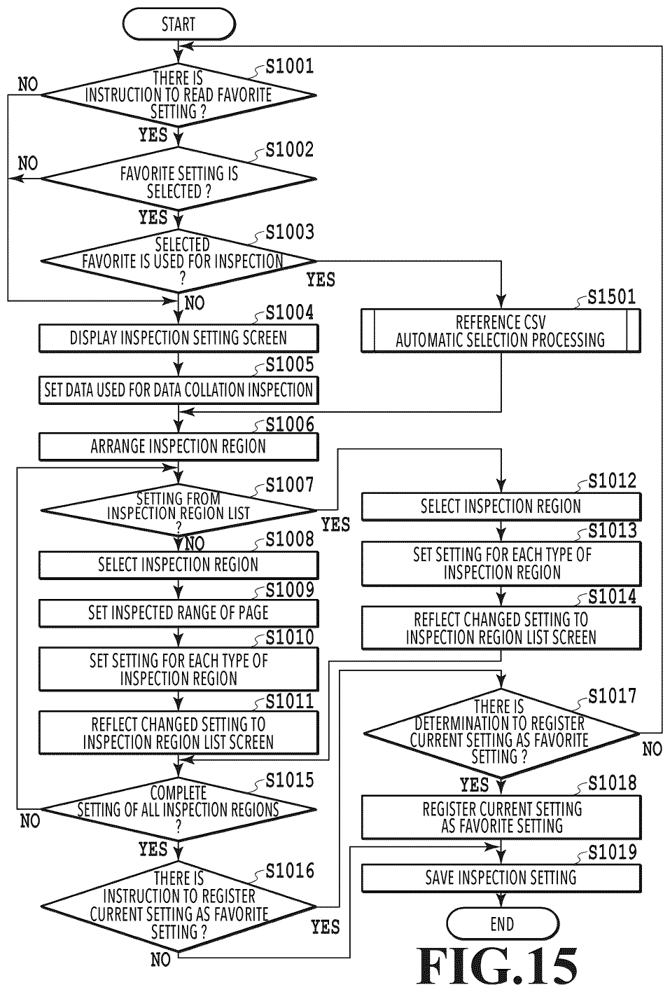

FIG. 15 is a flowchart illustrating a detailed processing procedure of the inspection setting processing in the present embodiment. In response to the operation from the inspection setting screen and the inspection region list displayed on the operation unit/display unit 505 of the inspection apparatus 120, the control unit 503 of the inspection apparatus 120 executes the various types of processing to perform the inspection setting.

Subsequent to the processing in S1001, S1002, and S1003 described in the first embodiment with reference to FIG. 10, the processing proceeds to S1501. In S1501, the control unit 503 executes processing to automatically select and set the reference CSV file used for the inspection.

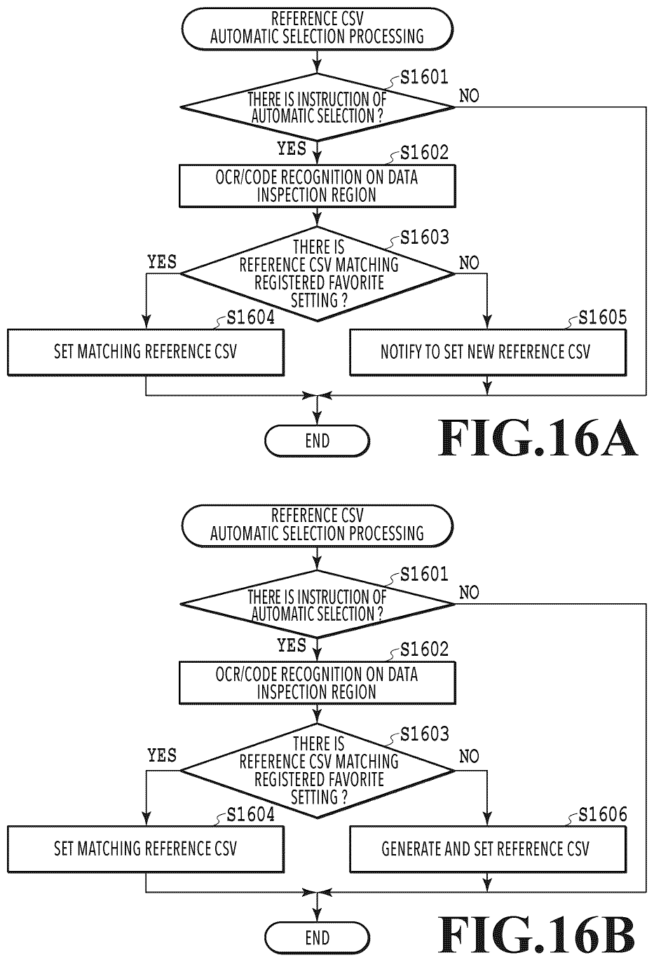

FIG. 16A is a flowchart describing a detailed processing procedure of the reference CSV file automatic selection processing in S1501. The reference CSV file automatic selection processing is implemented with the control unit 503 in the CPU 221 of the inspection apparatus 120 executing a predetermined program corresponding to the flowchart in FIG. 16A. First, in a case where the operation is received from the inspection setting screen and the inspection region list displayed on the operation unit/display unit 505 of the inspection apparatus 120, the control unit 503 of the inspection apparatus 120 executes various types of processing to perform the inspection setting.

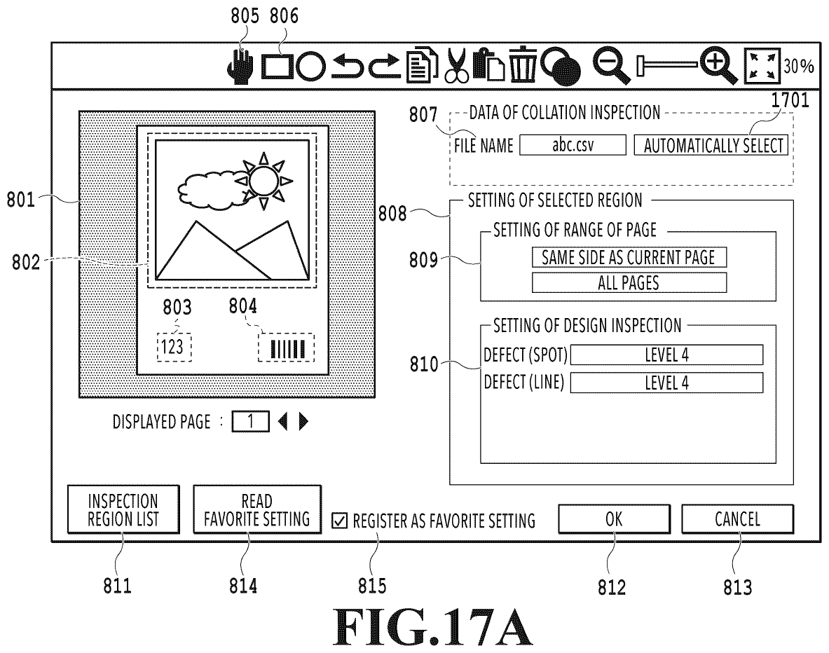

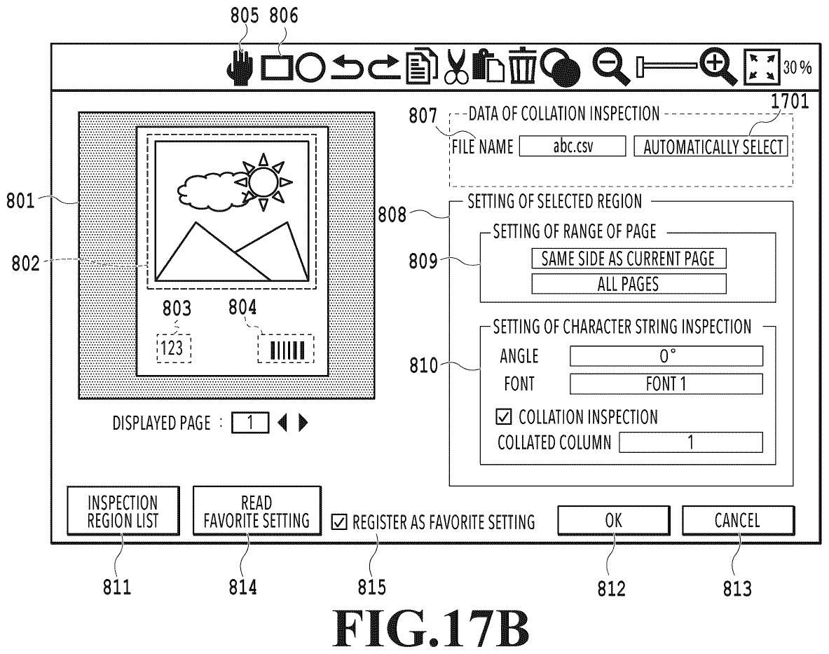

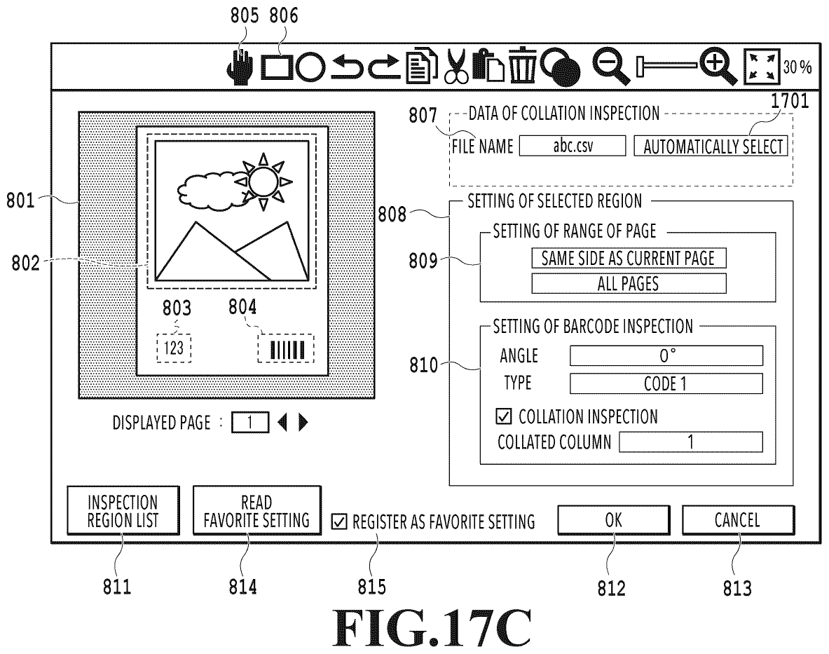

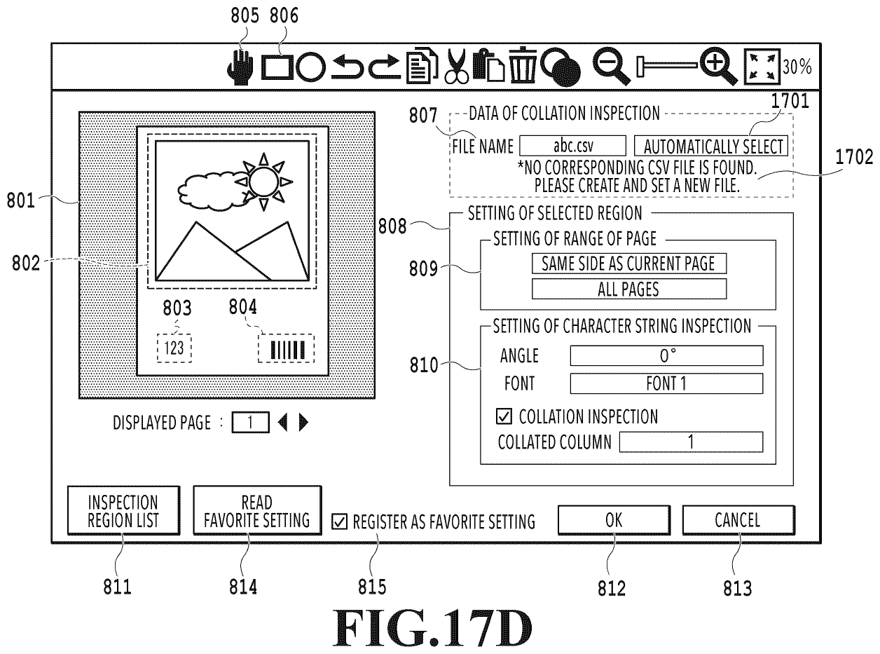

In S1601, the control unit 503 determines whether there is the instruction of the automatic selection of the reference CSV file from the user. FIGS. 17A to 17C are diagrams illustrating an inspection setting screen in the present embodiment. In addition to the constituents on the screen described in FIGS. 8A to 8C, an automatic selection button 1701 to automatically select the reference CSV file used for the collation inspection is arranged. The determination in S1601 is performed by the determination by the control unit 503 whether the automatic selection button 1701 is pressed. That is, in a case where the automatic selection button 1701 is pressed by the user (S1601 is Yes), the processing proceeds to S1602. In a case where the automatic selection button 1701 is not pressed by the user (S1601 is No), the processing flow illustrated in FIG. 16A ends.

In S1602, based on the favorite setting read in S1017, the control unit 503 executes the character string recognition processing and the code recognition processing on the region 803 (the character string inspection region) and the region 804 (the code inspection region), respectively, and the processing proceeds to S1603. In S1603, the control unit 503 searches the already registered favorite setting for the reference CSV file with the matching display field 910 of the collated column that corresponds to the results of the character string recognition and the code recognition on each inspection region that are executed in S1602. As a result of the searching, in a case where there is the corresponding reference CSV file (S1603 is Yes), the processing proceeds to S1604. In a case where there is no corresponding reference CSV file (S1603 is No), the processing proceeds to S1605.

In S1604, the control unit 503 sets the reference CSV file searched in S1603 to the setting item 807 as the collation inspection data used for the inspection and ends the processing flow illustrated in FIG. 16A. In S1605, since there is no corresponding reference CSV file in the already registered favorite setting in the inspection this time, the control unit 503 notifies the user to create and set a new file. In a case where the notification is performed, the processing flow illustrated in FIG. 16A ends.

FIG. 17D is a diagram illustrating an example of the notification in S1605. The notification is performed by displaying a notification message 1702 on the inspection setting screen. The notification may be performed by another method. With the present disclosure being executed by the above-described method, in a case where there is the data of the collation inspection used for the inspection in the reference CSV file used for the favorite setting registered before then, it is possible to execute the inspection setting further easily and simply with the automatic searching and setting.

### Modification of Second Embodiment

As a modification of the present embodiment, an example in which an appropriate reference CSV file is automatically generated in a case where no appropriate reference CSV file is found in S1603 is described.

FIG. 16B is a flowchart in the present modification to describe a detailed processing procedure of the reference CSV file automatic selection processing in S1501. The processing is implemented with the control unit 503 in the CPU 221 of the inspection apparatus 120 executing a predetermined program corresponding to the flowchart in FIG. 16B. First, in a case where the operation is received from the inspection setting screen and the inspection region list displayed on the operation unit/display unit 505 of the inspection apparatus 120, the control unit 503 of the inspection apparatus 120 executes various types of processing to perform the inspection setting.

In a case where the determination in S1603 described above is No, the processing proceeds to S1606 in the present modification. In S1606, the control unit 503 generates an appropriate reference CSV file based on the results of the character string recognition processing and the code recognition processing that are obtained in in S1602 and the information in the display field 910 of the collated column of the favorite setting read in S1017. More specifically, the character string recognition result or the code recognition result of each inspection region as the collation inspection target that is obtained in S1602 is written into a column based on the information in the display field 910 of the collated column. In addition, the reference CSV file is automatically generated by creating the collation data in a CSV format, and the generated reference CSV file is set to the setting item 807 as the collation inspection data used for the inspection. Thus, the processing flow illustrated in FIG. 16B ends.

In the above-described description, it is described that the reference CSV file is automatically generated; however, it is not limited thereto. It is also possible to automatically register the inspection setting using the automatically generated reference CSV file as the favorite setting (template).

As described above, even in a case where there is no data of the data collation inspection used for the inspection in the reference CSV file used for the favorite setting registered before then, it is possible to automatically generate and set the appropriate reference CSV file. Thus, it is possible to further improve the usability in a case of setting the inspection using the template.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-004590, filed Jan. 16, 2024, which is hereby incorporated by reference herein in its entirety.

What is claimed is:

1. An information processing apparatus configured to inspect a printed sheet, comprising:
a storage unit configured to store data of a correct character string used for data collation inspection in association with a template including contents of inspection setting in a case where a type of the inspection includes the data collation inspection in which whether a specific character string is printed correctly on the printed sheet is determined by collating with the correct character string;
at least one memory that stores instructions; and
at least one processor that executes the instructions to:
perform the inspection setting based on a template selected by a user from the template stored in the storage unit; and
control a user interface screen configured to allow the user to perform the selection, wherein
the data of the correct character string associated with the template selected by the user is displayed on the user interface screen while allowing for changing of the data.

2. The information processing apparatus according to claim 1, wherein the at least one processor executes the instructions further to:
set newly prepared data of a character string as the data of the correct character string used for the data collation inspection in a case where it is determined that there is no data of the correct character string used for the data collation inspection in the template stored in the storage unit.

3. The information processing apparatus according to claim 2, wherein the at least one processor executes the instructions further to:
store the newly prepared data of the character string in the storage unit in association with the template including the contents of the inspection setting in a case where it is determined that there is no data of the correct character string used for the data collation inspection in the template stored in the storage unit.

4. The information processing apparatus according to claim 1, wherein the at least one processor executes the instructions further to:
automatically change the data of the correct character string corresponding to the data collation inspection.

5. The information processing apparatus according to claim 4, wherein the at least one processor executes the instructions further to:
set the data of the correct character string used for the template as the data of the correct character string corresponding to the data collation inspection in a case where it is determined that there is the data of the correct character string used for the data collation inspection in the template stored in the storage unit.

6. The information processing apparatus according to claim 4, wherein the at least one processor executes the instructions further to:
notify of a fact that no data of the correct character string corresponding to the data collation inspection is stored in the storage unit in a case where it is determined that there is no data of the correct character string used for the data collation inspection in the template stored in the storage unit.

7. The information processing apparatus according to claim 6, wherein the at least one processor executes the instructions further to:
display contents of the notification on the user interface screen.

8. The information processing apparatus according to claim 4, wherein the at least one processor executes the instructions further to:
set a newly prepared character string as the data of the correct character string corresponding to the data collation inspection in a case where it is determined that there is no data of the correct character string used for the data collation inspection in the template stored in the storage unit.

9. The information processing apparatus according to claim 8, wherein the at least one processor executes the instructions further to:
automatically store the data of the newly prepared character string in the storage unit in association with the template including the contents of the inspection setting.

10. The information processing apparatus according to claim 1, wherein
the contents of the inspection setting include region information of the data of the correct character string.

11. The information processing apparatus according to claim 1, further comprising:
a reception unit configured to receive a scanned image on which the printed sheet is scanned, wherein the at least one processor executes the instructions further to:
extract a character string from the scanned image; and
determine in the data collation inspection whether a specific character string is printed correctly on the printed sheet by collating the extracted character string with the correct character string prepared in advance.

12. A method of controlling an information processing apparatus configured to inspect a printed sheet, the method comprising:
storing data of a correct character string used for data collation inspection in a storage unit in association with a template including contents of inspection setting in a case where a type of the inspection includes the data collation inspection in which whether a specific character string is printed correctly on the printed sheet is determined by collating with the correct character string;
performing the inspection setting based on a template selected by a user from the template stored in the storage unit; and
controlling a user interface screen configured to allow the user to perform the selection, wherein
in the controlling, the data of the correct character string associated with the template selected by the user is displayed on the user interface screen while allowing for changing of the data.

13. An inspection system including a printing apparatus configured to perform printing on a sheet based on image data designated by a printing job and an inspection apparatus including an information processing apparatus inspecting a printed sheet and being configured to perform the inspection on the printed sheet, wherein the information processing apparatus comprises:
a storage unit configured to store data of a correct character string used for data collation inspection in association with a template including contents of inspection setting in a case where a type of the inspection includes the data collation inspection in which whether a specific character string is printed correctly on the printed sheet is determined by collating with the correct character string;
at least one memory that stores instructions; and
at least one processor that executes the instructions to:
perform the inspection setting based on a template selected by a user from the template stored in the storage unit; and
control a user interface screen configured to allow the user to perform the selection, and
the data of the correct character string associated with the template selected by the user is displayed on the user interface screen while allowing for changing of the data.

14. The inspection system according to claim 13, wherein the at least one processor of the information processing apparatus executes the instructions further to:
set newly prepared data of a character string as the data of the correct character string used for the data collation inspection in a case where it is determined that there is no data of the correct character string used for the data collation inspection in the template stored in the storage unit.

15. The inspection system according to claim 14, wherein the at least one processor of the information processing apparatus executes the instructions further to:
store the newly prepared data of the character string in the storage unit in association with the template including the contents of the inspection setting in a case where it is determined that there is no data of the correct character string used for the data collation inspection in the template stored in the storage unit.

16. The inspection system according to claim 13, wherein the at least one processor of the information processing apparatus executes the instructions further to:
automatically change the data of the correct character string corresponding to the data collation inspection.

17. The inspection system according to claim 16, wherein the at least one processor of the information processing apparatus executes the instructions further to:
set the data of the correct character string used for the template as the data of the correct character string corresponding to the data collation inspection in a case where it is determined that there is the data of the correct character string used for the data collation inspection in the template stored in the storage unit.

18. The inspection system according to claim 16, wherein the at least one processor of the information processing apparatus executes the instructions further to:
notify of a fact that no data of the correct character string corresponding to the data collation inspection is stored in the storage unit in a case where it is determined that there is no data of the correct character string used for the data collation inspection in the template stored in the storage unit.

19. The inspection system according to claim 18, wherein the at least one processor of the information processing apparatus executes the instructions further to:
display contents of the notification on the user interface screen.

20. The inspection system according to claim 13, wherein the information processing apparatus further comprises:
a reception unit configured to receive a scanned image on which the printed sheet is scanned, and
the at least one processor of the information processing apparatus executes the instructions further to:
extract a character string from the scanned image; and
determine in the data collation inspection whether a specific character string is printed correctly on the printed sheet by collating the extracted character string with the correct character string prepared in advance.
